(19) United States
(12) Patent Application Publication
(10) Pub. No.: US 2010/0293108 A1
(43) Pub. Date: Nov. 18, 2010

(54) Automated Practice Management System

(76) Inventors: Sam Gurvitch, Scarsdale, NY (US); Don Jacobs, Bellerose, NY (US)

Correspondence Address: JACKIE JAY SCHWARTZ, 245 Fifth Avenue, Suite 1902, NEW YORK, NY, 10016, US

(21) Appl. No.: 12/780,541

(22) Filed: May 14, 2010

Related U.S. Application Data
(60) Provisional application No. 61/178,254, filed on May 14, 2009.

(51) Int. Cl. G06Q 40/00

(52) U.S. Cl. 705/36 R; 705/37

(57) ABSTRACT

A practice management method and system includes a repository for storing client information data including at least one client identifier and at least one client characteristic associated with the client. Client account data is also stored and identifies at least one account linked to the client via the at least one client identifier, the client account data includes data representing a financial portfolio associated with the client and having an initial balance value and a risk value. A risk allocation profile data is stored in the repository and includes a risk allocation profile type and a risk allocation value. A data processor is electrically coupled to the repository and acquires the client information data and the client account data including the financial portfolio having the initial balance value and calculates an updated balance value for the financial portfolio based on the risk allocation profile type and comparing the risk allocation value of the risk allocation profile type with the risk value of the financial profile data. The data processor modifies the client account data in response to the comparison to include the calculated updated balance value for the financial portfolio data.

### CROSS-REFERENCE TO RELATED APPLICATIONS

This application claims priority from Provisional Application Ser. No. 61/178,254 filed on May 14, 2009 by Sam Gurvitch et al.

### FIELD OF THE INVENTION

The invention concerns a system and method for automating tasks associated with managing the practice of a financial or other professional by automatically aggregating client data from various sources for use in providing professional services to the client.

### BACKGROUND OF THE INVENTION

Known systems include individual tasks that are automated enabling a professional to partially improve the efficiency with which they work to serve their clients. However, known systems fail to include a plurality of different forms representing different tasks which are automatically populated from a source of client data. Thus, known systems are unable to offer a system that alleviates the need to handwrite all practice management tasks via forms which is a time consuming task that also leaves room for clerical errors. This benefit fosters quicker handling of tasks while reducing error rates. A system and method according to invention principles addresses these deficiencies and related problems.

### SUMMARY OF THE INVENTION

A practice management method and system includes a repository for storing client information data including at least one client identifier and at least one client characteristic associated with the client. Client account data is also stored and identifies at least one account linked to the client via the at least one client identifier, the client account data includes data representing a financial portfolio associated with the client and having an initial balance value and a risk value. A risk allocation profile data is stored in the repository and includes a risk allocation profile type and a risk allocation value. A data processor is electrically coupled to the repository and acquires the client information data and the client account data including the financial portfolio having the initial balance value and calculates an updated balance value for the financial portfolio based on the risk allocation profile type and comparing the risk allocation value of the risk allocation profile type with the risk value of the financial profile data. The data processor modifies the client account data in response to the comparison to include the calculated updated balance value for the financial portfolio data.

A computer readable medium including machine executable program code embodied thereon, said machine executable code being executed by a computing device to implement the method provided above and described hereinafter.

### BRIEF DESCRIPTION OF THE DRAWING FIGURES

FIGS. 1-10 are exemplary screen shots of the various display images generated by the automated practice management system and used for entering different types of data according to invention principles;

FIG. 11 is an exemplary screen shot of a display image generated by the automated practice management system and used in calculating and balancing client accounts according to invention principles;

FIG. 12 is an exemplary screen shot of a display image generated by the automated practice management system used in facilitating communication between different parties according to invention principles;

FIGS. 13 and 14 are exemplary screen shot of display images generated by the automated practice management system associated with client transactions according to invention principles;

FIG. 15-19 are exemplary screen shots of display images generated by the automated practice management system associated with various reports and includes various filtering options implemented in reports according to invention principles;

FIG. 20-24 are exemplary screen shots of display images generated by the automated practice management system associated with reference tables used by the system according to invention principles;

FIGS. 25-37 are exemplary screen shots of display images of reports that are output and generated by the automated practice management system according to invention principles;

FIG. 38 is an exemplary screen shot of a display image generated by the automated practice management system showing client contacts according to invention principles;

FIG. 39 is a block diagram of the automated practice management system according to invention principles;

FIGS. 40 and 41 are a flow diagram identifying data relationships between data table employed by the automated practice management system according to invention principles; and

FIGS. 42-45 are flow diagrams of algorithms defining operation of various features of the automated practice management system according to invention principles.

### DETAILED DESCRIPTION

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

Workflow comprises a sequence of tasks performed by a device or worker or both. An object or data object comprises a grouping of data, executable instructions or a combination of both or an executable procedure. A document or record comprises a compilation of data in electronic or paper form. A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Log-In screen (not shown) is automatically generated by the system when a user initiates execution of an executable application using a computing device. Alternatively, the log-in screen may be automatically generated upon powering-up of a specific purpose terminal including the automated practice management system. The log-in screen enables a user to enter via an input device (keyboard, mouse, touch-screen display, etc) data representing user information which is required prior to accessing additional system functions. The user employs at least one type of input device to enter user access information into at least one user access data field displayed within the log-in screen. Upon receipt of user-entered access data, the system implements an authorization process controlled by an authorization processor, for example. The authorization processor implements a comparison and/or checking algorithm that compares the data entered in the at least one user access data field with data stored in a user access repository which includes information identifying users authorized to access the system as well as permission information identifying at least one of a level and priority of access available to the particular user. If the comparison algorithm implemented by the authorization process returns a match, then the user is granted access in accordance with the permission information associated with the user. Additionally, the system automatically generates display of the log-in screen if the system (or computer executing an application from a computer readable medium) receives no user input for a predetermined amount of time. For example, should the system be inactive for 24 hours, the system automatically generates a display image representing the log-in screen in order to solicit user access information from a user. Alternatively, a display image representing the log-in screen is automatically generated when a user accesses a predetermined form, for example, the Main Data Entry from for the first time that next day. This provides for limited database access to only those individuals that should have access in accordance with the permission information associated with the user. This advantageously protects the database from any unwelcome or unauthorized individuals.

In an alternate embodiment, the system includes an executable procedure that operates in response to user entry of user access data that automatically initiates a security feature that enables the system to automatically initiate communication, via a network, with an authorization server that receives data representing user access information and compares the received access data with data in a repository that includes all authorized user access data. The authorization server compares the data, and upon determining that a match exists in the repository, the authorization server automatically communicates a message via the network, to the system indicating the user is authorized. Additional access authorization may be performed randomly, regularly or at a predetermined time interval which corresponds to a particular date associated with a client license, for example the end-date of a subscription. Upon receipt of the message, the system enables the user to access additional system features by enabling access to a plurality of display images including image elements that are able to initiate additional executable procedures representing different system functions such as those described below.

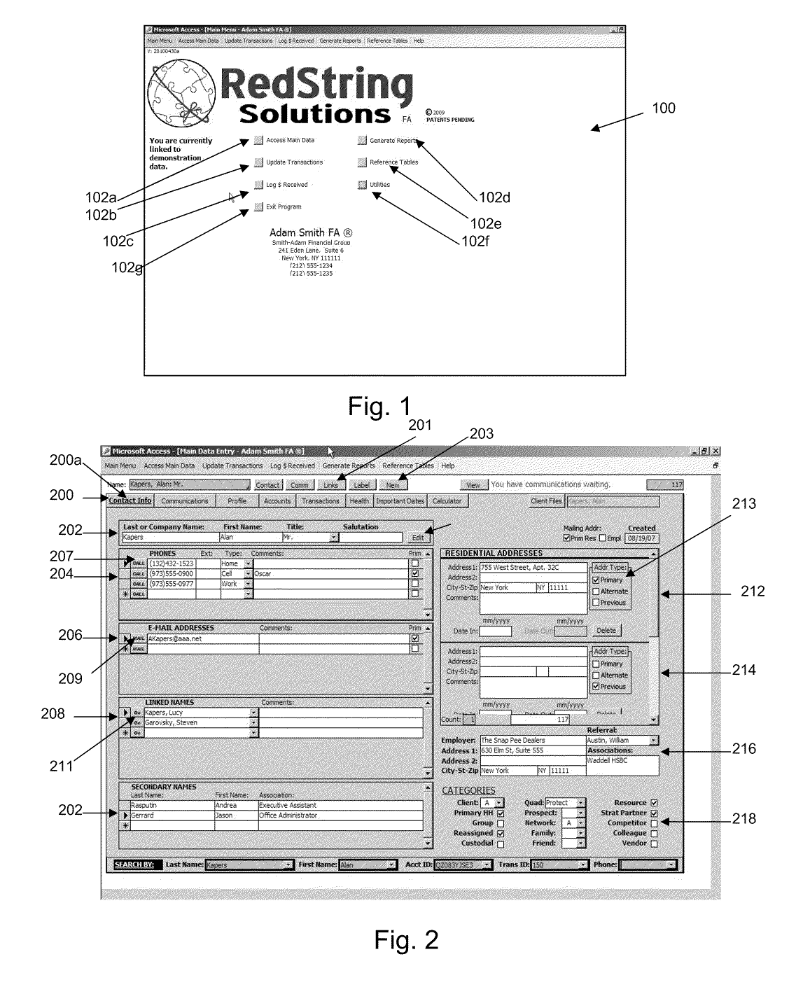

FIG. 1 is an exemplary screen shot of a display image generated by a user interface processor of a main menu 100 enabling a user to access the various features of the automated practice management system. The menu 100 is selectively presented to a user upon entry of access control information by a user and a determination by the system that the user entered access information is valid. The main menu display screen 100 includes a plurality of user selectable image elements 102a-102g including image element identifiers that identify the feature accessible by selecting the particular image element. The image elements displayed in FIG. 1 correspond to features of the system. Selection of a particular user selectable image element initiates at least one of an executable procedure or application associated with the feature listed adjacent the image element. Upon selection of an image element corresponding to a system feature, the executable procedure/application is loaded into system memory and initiates generation of a display image corresponding to the selected system feature. As shown herein, the user selectable image elements enable a user to initiate executable procedures/applications for (a) accessing a database including all client information, (b) updating practice transactions, (c) entering/logging data representing funds received/forwarded from clients/to agencies (once funds received, what happens to them), (d) generate reports associated with at least one client or at least one group of clients, (e) accessing and manipulating reference tables including data that may be accessed by other features of the system, (f) a utility management application and (g) exiting the system.

The utility management application associated with image element 102g initiates an executable procedure that generates a plurality of secondary image elements enabling a user to activate additional management applications for controlling various options embedded in the system. The utility management image elements include (a) importing data from an external source, (b) Program Updates utility for updating program features, (c) a utility for linking the Program Front-End to Back End Data sources, (d) a utility enabling selection of an Integrated Phone System for use in communicating with clients and other third parties (e) a utility management enabling a user to delete any empty <accidental> name Records, (f) method for ranking and/or categorizing contacts, (g) enabling/disabling hyperlink warnings. The above utilities may, for example, be displayed as image element buttons entitled Import Data, Update Back End, Delete Empty Names, Relink Data, IP Phone Service, Enter Ranking Data, Disable Hyperlink Warning, Enable Hyperlink Warning.

Alternatively, upon selection of a respective image element, system initiates generation of a log-in screen shown that requires user input of user access information, for example user log-in and password, in order to access the selected system feature. Thus, the system is designed to implement strict security measure to control access to system functions that are made available to the user based on a defined level of access. System access may be defined his is significant for security purposes. The system, upon selection of a particular image element, may automatically initiate generation and communication of an authorization message including data representing a feature request which is transmitted via a communication network to an authorization server which determines if the user accessing the program is able to access a particular feature by comparing the feature request data with access data in a level of access agreement between the user and a third party owner of the system to see if the feature is accessible to that particular user. For example, a tiered access agreement whereby a user is able to access a subset of system features for a particular price. If the feature request data is associated with a feature in the subset, then, the authorization server generates and transmits an access approved message and the user is able to access the particular feature. If the feature is determined to be outside of the subset, then the authorization server generates and transmits a message to the user of the system indicating that the feature is not available and provides information on how to obtain access to the requested feature. For example, the message may include fields or a form whereby the user can automatically modify their access level by entering payment information or agreeing to additional terms which would allow the user to access the requested feature.

FIGS. 2-10 are exemplary screen shots of various forms that may be generated by selecting the access main data entry image element 102a in FIG. 1. Selection of the main data entry image element 102a initiations the executable procedure that includes generation of the display images shown in FIGS. 2-10 which allow a user to enter client data. The main data entry form (MDE form) includes a plurality of forms each having at least one subform display image associated therewith. The main data entry forms and subforms will be discussed below with respect to FIGS. 2-10. Each form is made available by a user selectable tab within the display image enabling quick toggling between forms allowing fast and efficient access to all data fields.

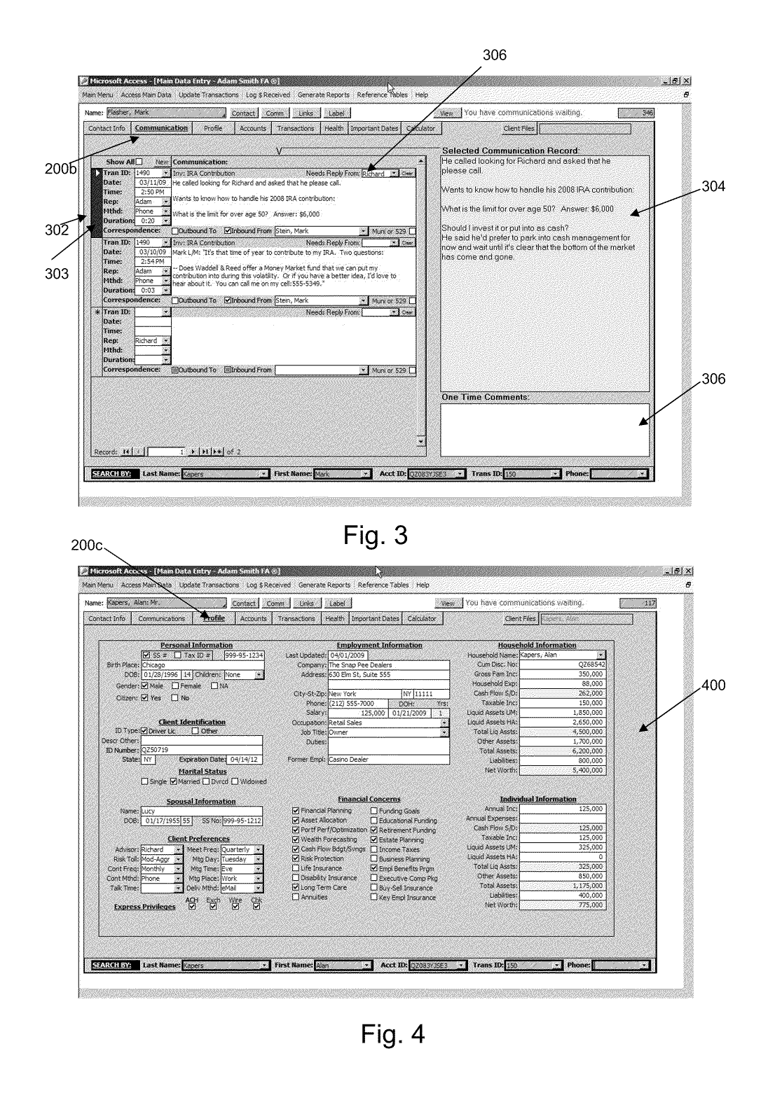

FIG. 2 is an exemplary screen shot of a display image generated by the system that includes a plurality data fields that enable user data entry of client data. FIG. 3 includes a user selectable image element toolbar 200 that allows a user to toggle between different display images representing different system functions. The toolbar is displayed in a tabbed arrangement wherein a respective tab represents a display image corresponding to a respective system function. As shown in FIGS. 2-10, the tabs enable toggling between display screens that receive (a) client contact information, (b) client communication information, (c) client financial profile information, (d) client account information, (e) client transaction information, (f) client health-related information, (g) important date information, and (h) calculation request and processing information.

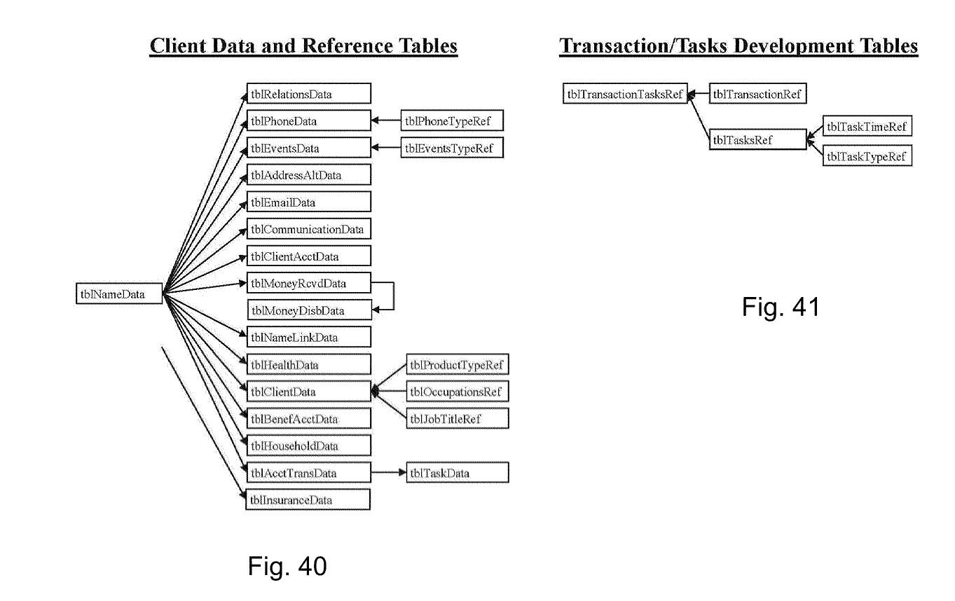

FIG. 2 illustrates the data entry application of the system whereby the user is able to selectively fill data fields with client data using at least one type of input device. The data entered in the respective data fields in FIG. 2 is stored in a respective one of the client data tables in a database as shown and will be described below with respect to FIG. 40. The data stored in the client data tables are selectively usable by other system functions as will be discussed below. The system is able to utilize any data entered in any data field of FIG. 2 because the system implements an executable procedure called “Forced Referencing”. As data is entered in a data field, an identifier corresponding to the entered data and the field in which it was entered is used by the system to automatically populate a further field having that identifier with the previously entered data. While this is described as occurring from the main data entry screen, the forced referencing procedure may be initiated from any system application when the user enters data into a data field for the first time. Forced Referencing is used wherever appropriate and possible. This minimizes the amount of required input from the user and finds the nearest matched spelling, promotes consistency and reduces errors. Consistently forcing entries advantageously facilitates efficient production of reports including correct information and running searches using accurate search terms. Additionally, the main data entry executable procedure generates error messages and warning labels for display when critical fields are left blank. Thus, the system advantageously provides a mechanism that helps the user remember to fill in data fields that supply information for various reports and information supplied to other executable applications or procedures associated with other system features. This helps foster more complete and accurate reports and fully integrates data amongst all of the modules of the system. Additionally, the main data entry display image includes an image element 201 enabling the user to automatically link a respective client contact a file folder on their workstation or server. The link button can be found on all MDE pages. This enables the user to quickly and easily access their clients' files without searching through Windows Explorer.

FIG. 2 illustrates the contact information tab 200a display image. The contact information tab includes a plurality of data windows associated with respective sub-forms. The user is able to selectively enter data into any of the data field in any of the sub-form windows. The term Contact Name will refer to a name that is associated with its own record. The term Client will be interchangeable with any type of Contact Name regardless or whether or not the Contact is a client. Wherever appropriate and possible, the data on this page can interface and synchronize with an external personal management and communication program such as OUTLOOK®. Importing and exporting data is also possible. The user can easily create a new Contact record simply by clicking on the “New” button 203 located within the MDE page display image. The user can modify a record's contact information by clicking the “Edit” button 205 to unlock protected field located next to the Contact's name. This prevents accidental modifications or deletion of a Contact's name. Data representing the contacts name is selectively input or modified via the contact name field 202.

FIG. 2 further includes a sub-form data window enabling user entry and display of phone numbers 204 and email addresses 206 associated with a particular client contact that was entered in field 202. Subforms include an unlimited number of fields to received data representing phone numbers and/or email addresses to be stored for each contact with the ability to classify a respective one of the input data as a particular data type. For example, the a user may selectively designate one of the input phone numbers and email address as “primary” which provides the data stored in those fields to other aspects of the system as needed. The ability to denote and classify a particular data type as a primary phone and primary email for each contact is significant for various reports. The classification of data type as primary is described for purposes of example only and other classification types may be included such as secondary, alternative, etc. Each phone number data field in phone number subform 204 includes a user selectable image element representing a CALL hot button 207 located adjacently thereto. In response to selection of the CALL button 207, the system initiates an executable procedure enabling a telephone call to be made to a client using the data representing the client phone number in that record. Using the CALL hot-button activates a simulated on-screen phone and the selected phone number is automatically dialed through an Internet phone link or modem setup as shown in FIG. 12. Each email data field in the email addresses subform 206 includes a user selectable image element representing a EMAIL hot button 209 located adjacently thereto. In response to selection of the EMAIL button 209, the system initiates an executable procedure that opens a blank email and inserts the email address in the “TO” field of the new email message. Using these hot-buttons is faster, more accurate and less disruptive than dialing or typing by hand. Clicking the CALL 207 or EMAIL 209 hot-buttons will also initiate generation of a communication record with the date, time, data representing a default duration may also be populated, method of the communication and indicate that the initiated communication is Outbound. The communication record is automatically stored in the database and is associated with the particular client information. An example of the communication records generated and stored in response to initiating at least one of an outgoing telephone call and email are shown in FIG. 37. This saves time and prevents the user from forgetting to document the call or email. Additionally, the communication record is automatically populated with client contact data derived from the various client contact data fields shown in FIG. 2.

Upon selection of the image element that initiates a call with a client, the system automatically initiates the digital phone executable procedure. This procedure causes a display image, such as the one shown in FIG. 12, to be displayed to a user. The phone application may be an Internet Phone feature capable of recording conversations and providing video conferencing between users and clients. Other phone features include but are not limited to voicemail, auto attendant, and follow-me. There is a transcription function which can be used with recorded phone conversations and dictation. Transcribing is handled by a voice recognition application that is initiated in response to selection of a transcription image element in the display image. Recording and transcribing help to quickly and easily maintain complete communication records for compliance purposes. It also allows the user to revisit the conversation at a later time and hone in on details or forgotten information. The digital phone executable procedure further enables a user with a camera and microphone coupled to the system to engage in video conferencing between the user and the client. This advantageously enables face-to-face meetings which is helpful for clients who prefer visual contact.

FIG. 2 further includes a linking subform data window 208 which enables a user to link a first client contact record with a second different client contact record. The Linked Name subform 208 includes at least one data field that allows a user to manually input an identifier associated with the second different client contact record or select from a list of identifiers in a list of clients that can be selected as the second different client contact record to be linked with the first client contact record. Additionally, the subform 208 includes a data field that allows a user to input comments associated with the second different client contact, for example, identifying a relationship between the first and second clients. The Linked Names sub-form 208 in the Contact Info tab 200a that allows the user to quickly and easily go between associated contacts in the system via a user selectable image element 211 that automatically switches between the linked contacts. Should more than two contacts be linked, selection of the image element results in serial scrolling between all linked contact records. The linking data entered in subform 208 is stored in a linking table of the system database and allows users to access this information when using the various features of the system as described herein.

The Contact Info tab 200a includes a secondary name sub-form 210 including data fields for information associated with the primary contact but are not distinct contacts that require their own record. For example, the secondary names sub-form includes Names listed here are associated with a CONTACT but themselves are not a CONTACT name (i.e. a CONTACT's secretary) and for which no other information is needed. This advantageously enables the user to directly target communications, for example, letters to a person that is responsible for attending to incoming communication.

Also included is at least one address subform data window 212 and 214 enabling entry and display of address data that is associated with the particular client contact. The address subform 212 includes a plurality of data fields that receive user input of data representing portions of the clients address. The address subform data window 212 includes image elements 213 that enable a user to classify of the data entered in the address data fields. An unlimited number of home and work addresses can be recorded and designated or classified as either primary, alternate or previous, with the primary addresses being exclusive to their respective categories (home or work). This is significant for insurance applications, and identifying and transferring assets held with previous employers. All addresses are displayed on this tab. In another embodiment, only Primary addresses will be displayed on the Contact Info tab. All addresses will be stored and modified on a different tab—OR—All addresses will be stored and modified on a different form that is accessed through the Contact Info tab. Additionally, the user can assign either the Primary Home or the Primary Work address as the designated Mailing Address. For all addresses, ‘Date In’ and ‘Date Out’ can be indicated along with comments. The system further enables a user to store a plurality of associated addresses for a particular client. The user can store here an unlimited number of office and residential addresses for their clients. This is advantageous because various entities may require additional information regarding a client prior to providing a service. For example, insurance companies usually require applicants to provide information about their past addresses. The user can also assign their client to an infinite number of associations (i.e. Rotary, network groups, and other organizational affiliations).

The Contact Info tab display image further includes a work address subform 216 including a plurality of data fields enabling a user to enter data representing a work address. The data entered by the user in the various data fields are stored in a work address table in the system database.

The system further comprises a category assignment subform 218 enabling user assign category data to the particular client record. Category data assignment may be accomplished by clicking a selection box corresponding to a particular type of category data. Alternatively, category data may be assigned via a drop down box whereby a candidate list of category data items are presented to the user for selection. The assigning of categories allows for rapid and effective filtering, extracting, and sorting of contacts for the purposes of target marketing, mail merging, mass-mailings, email blasts, and phone lists. This advantageously enables the user to target and devote correct proportions of their time and resources towards deserving contacts or clients that require different levels of service and business development. There are many categories which include but are not limited to those mentioned here. Some categories are designated with a check mark (i.e. Primary Household, Group, Reassigned, Custodial, Strategic Partner, Competitor, Colleague, Recruit, Vendor, etc. Others are designated by ranking them using letters A through E (i.e. Client, Prospect, Network, Family, Friend). There is also a category, ‘Quadrant’ for denoting the level of cultivating desired by the user Quadrant using the following four designations: Develop, Protect, Monitor, Maintain. Additionally, each contact can be grouped by various associations found on the tab ‘Addresses & Associations’.

FIG. 3 is an exemplary display image of the communications tab 200b of the main data entry application being executed by on the system. The communication form advantageously enables all data resulting from a client interaction to be documented, stored and associated with the particular client record. The client interaction data is stored in a client interaction record in the system database. The client interaction data is displayed in a client interaction subform 302. When a user selects a particular client interaction, data representing the client interaction is displayed in an interaction display window 304. The client interaction data includes at least one type of client interaction identifier 303 identifying the particular type, time and content of the client interaction. Client interaction identifiers include at least one of (a) a unique transaction identifier, (b) a date of communication, (c) a time of communication, (d) a person who received or initiated the communication, (e) the method of the communication, (f) data representing the duration of time for the communication; and (g) a type of communication (inbound, outbound, intra-office, etc). Each communication can be linked to a client, transaction, staff member, method of communication, and duration. Additionally, you can indicate whether the communication was in or out bound and with whom the communication was with, and whether it involved a municipal bond or 529 Plan. This information is particularly significant for automatically generating federally mandated correspondence logs. It also allows the user to generate very comprehensive activity history and communication reports pertaining to a client, transaction, staff member, or activity type within a selected date range. The default for the TID field 302 of FIG. 3 is to show only a drop-down list of open transactions corresponding to the contact name. Optionally, you can view both open and closed transactions. Since it is more common to be communicating about open transactions, the default shows only the open ones keeping the user from being inundated with a constantly growing list. There is reply requested data field 306 that allows a user to selectively identify a person who is responsible for handling the subject of the communication. The data stored in the client interaction records allows a user to automatically compile a report that lists all calls or emails that were made and indicate where a reply is needed.

Additionally, the system provides a free-form text subform data window 306 enabling user entry of free-form text comments that are associated with the client. The comments box is intended to be used to store static information about the contact. It is strategically placed on the Communication tab so it is visible whenever calling or emailing a Contact. This advantageously presents the user with the most up-to-date notes regarding the client and any previous communications between the user and the client.

FIG. 4 is an exemplary display image of client profile form 400 that is displayed upon selection of the client profile tab 200c. Each respective client has a unique client profile including data representing relevant information about the client. The profile form includes a plurality of data fields enabling user entry of pertinent information which may be used in automatically populating additional data fields associated with other system functions. The client profile form assists the User in complying with Federally Mandated requirements to fully “know your customer.” The client profile form allows the user to store critical client data necessary for completing applications manually or via auto-population feature. Client profile data includes but is not limited to: SS/Tax ID number, citizenship, government ID information, date of birth, marital information, individual finances, household finances, occupational information, assignment of account privileges, the client's financial concerns and preferences regarding customer service. These data fields populated for respective clients in the client profile data form 400 are able to be accessed by other features of the system for use in searches, filters and reports that are associated with the particular client or a group of clients that are of a specific client type, i.e. any clients who have a household income over a predetermined threshold value. The entry of client profile information is accomplished by at least one of manually filling in data fields, selecting image elements denoting particular data items and selection from a candidate list of client profile data.

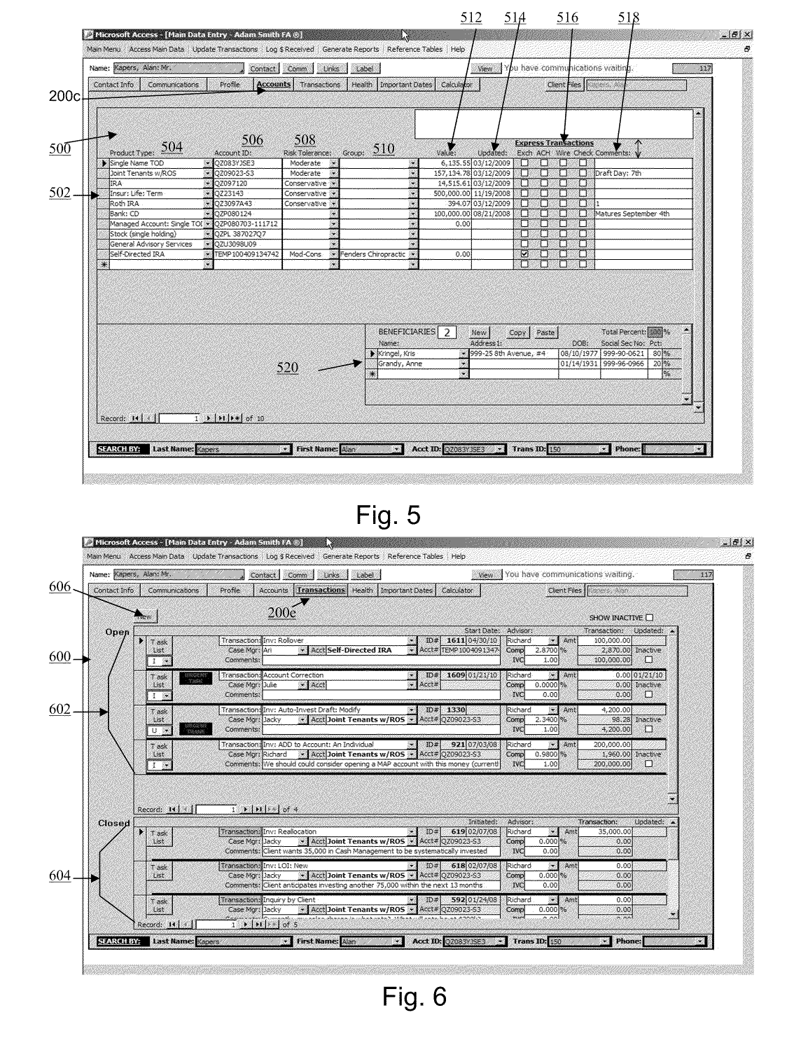

FIG. 5 is an exemplary display image generated by upon selection of the Accounts tab 200d. The display image is a client account form 500 and includes an itemized list of a client's accounts. The list of client accounts are shown in an account subform 502. For each client account record, the user can selectively identify a plurality of different features of the particular client account record. An individual client account record includes (a) a product type field 504 including data representing a product type defining a type of financial product, (b) an account identifier including data representing a unique value identifying the account, (c) a strategy field 508 including data identifying a financial strategy associated with the account, (d) group identifier information field 510 including data specifying if the account is offered/provided by a specific group, (e) a value field 512 including data representing the value of the account (the value may be automatically retrieved from a repository or account balance will be imported daily via a daily feed from a third party), (f) a date field 514 including data identifying when any account information had been updated recently and (g) a comment field 518 for receiving user input of data regarding the account. The account subform 502 also includes a transaction type selector 516 that allows the user to specify the types of transaction that are associated with the account including an ACH transfer, wire transfer, checks, etc. These transaction types are described for purposes of example only any type of financial transaction may be associated with a particular client account. Client account data in respective fields of subform 502 are selectively accessible by reporting and referencing features of the system in order to provide the user with a complete picture of the client's financial information and allow the user to modify client information in accordance with client preferences such as risk strategy. When an account's value is modified, the corresponding ‘Date Updated’ field is overwritten with the date of the modification letting the user know how current the data is. These values can be updated with a daily feed from a third party financial data house. Each account can be linked to a group or household account. This enables the user to connect individual accounts with group benefit plans for reports and referencing. There is a column for ‘Account Anniversary’ which is a relevant date in the financial services industry. The date entered for any given account will auto-populate to the list of ‘Important Dates’. This helps bring the date to the user's attention at the appropriate time and is helpful with other reports. Account balances are totaled for easy referencing. The data input by the user or automatically populated due to the forced referencing of a value is stored in a client account data table in the database of the system. This data is automatically accessible to other features of the system that require client account data in order to operate.

Also included is a beneficiary subform 520 including data fields that may be populated by the user to designate an individual as a beneficiary of a particular account shown or listed in the accounts subform 502. As a user selects different accounts, the data fields in the beneficiary subform 520 are automatically changed to show the beneficiary for that account. In this manner, the user can modify beneficiary data for each account. Data fields in the beneficiary subform include beneficiary name, beneficiary address, beneficiary date of birth, beneficiary tax identification number and a beneficiary percentage defining an amount allocated to the particular beneficiary. Name Records that exist in the database can be selected as a beneficiary. When selected, the system will auto-populate the other corresponding fields with the available information. Thus, depending on various estate planning rules and specifications, a single client account may include a plurality of beneficiaries associated therewith. The beneficiary data entered via the fields in subform 520 is stored in a beneficiary data table in the system database. This data is automatically accessible to other features of the system that require client account data in order to operate.

Alternatively, the beneficiary information in subform 520 may be displayed in a display image generated by the system that corresponds to a beneficiaries tab of the Main Data Entry application. All beneficiary information for a respective client account is listed here. This helps keep track of beneficiaries' birthdays. This page includes at least two display windows including types of beneficiary data. In a first beneficiary display window, a list of beneficiaries are presented to a user. In response to selecting a listed beneficiary, the system automatically generates a display image in the second display window including a list of accounts for which they are beneficiaries is displayed on the bottom half. The list of beneficiaries and accounts can be modified, added to or deleted. The user can indicate the percentage designated for each beneficiary and the related account. The significance of this is that it provides flexibility with the percentage breakdown for each account as they may differ from account to account depending on the client's instructions.

FIG. 6 is an exemplary transaction display image 600 generated by the system showing open and closed transactions associated with a particular client. The transaction display image 600 is automatically displayed upon user selection of the transactions tab 200e. The transaction display image 600 includes an open transaction subform 602 and a closed transaction subform 604. The subforms 602 and 604 are displayed in a split screen with Open Transactions 602 including any data representing open transaction records appearing on top and Closed transactions including data representing closed (completed) transactions appearing on the bottom. Each subform 602 and 604 includes at least one transaction record identifying a transaction associated with the client. This tab 200e enables the user to initiate client transactions, for example, reallocation of funds from one account to a second different account. The transaction form further includes user selectable image elements and data fields enabling updating existing transactions for the selected client. Both ‘Open’ and ‘Closed’ transactions are displayed and accessible here. The user also has the ability to designate an open transaction as either ‘active’ or ‘inactive’. A transaction might be deemed inactive due to lack of progress possibly by the client wanting to put an open transaction on hold. By default, only active transactions are displayed. The default reduces clutter helping the user focus on active transactions. The user can elect to display all. An individual client transaction record includes user modifiable data fields for classifying the particular transaction stored in the record. An individual client transaction record includes data fields including data representing a (a) transaction type data field defining the type and nature of the transaction, (b) a transaction identifier field including a unique value associated with the transaction (c) at least one personnel identifier field including data identifying personnel associated with the client or the transaction, (d) an account type data identifying the account associated with the transaction, (e) account identifier data, (f) a compensation field identifying a cost to the client for performing the transaction, and (g) a date field including the date the transaction was at least one of performed, updated or modified. The case manager, Advisor, transaction amount, compensation, incentive volume credit and priority level are entered via the fields described above. The user can assign priority levels for each transaction: Important (I), Urgent (U), Urgent and Important (UI). This is significant in making sure that the To-Do Lists and Transaction Status Reports generate items in order of priority which helps the user focus first on issues that require their immediate attention.

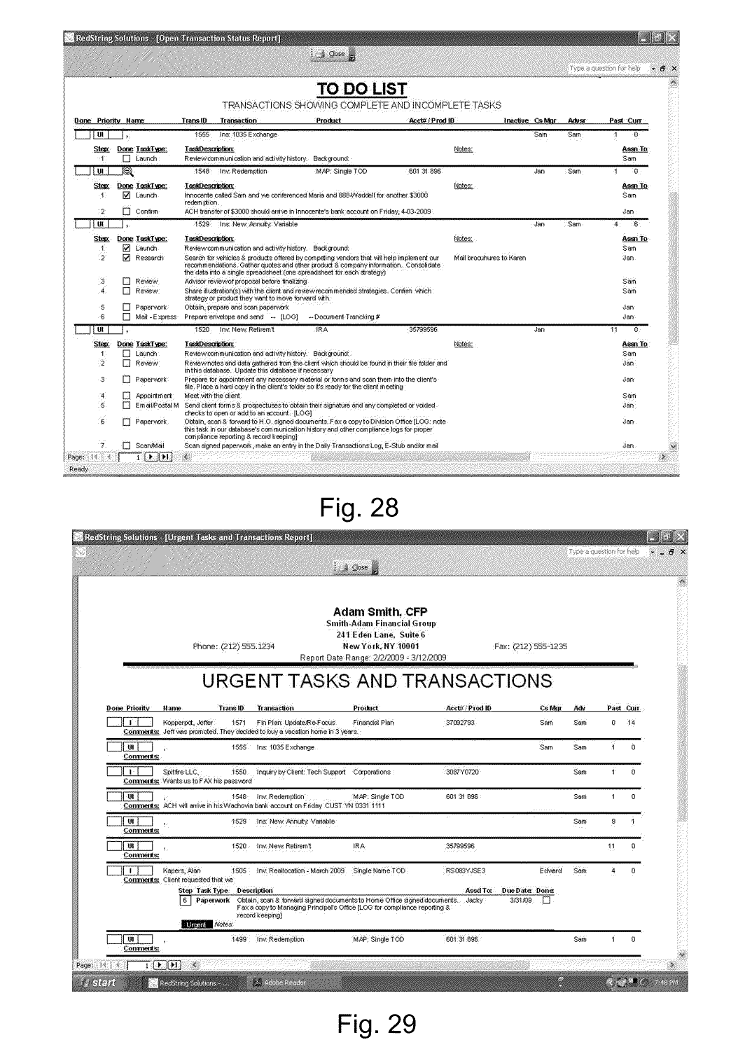

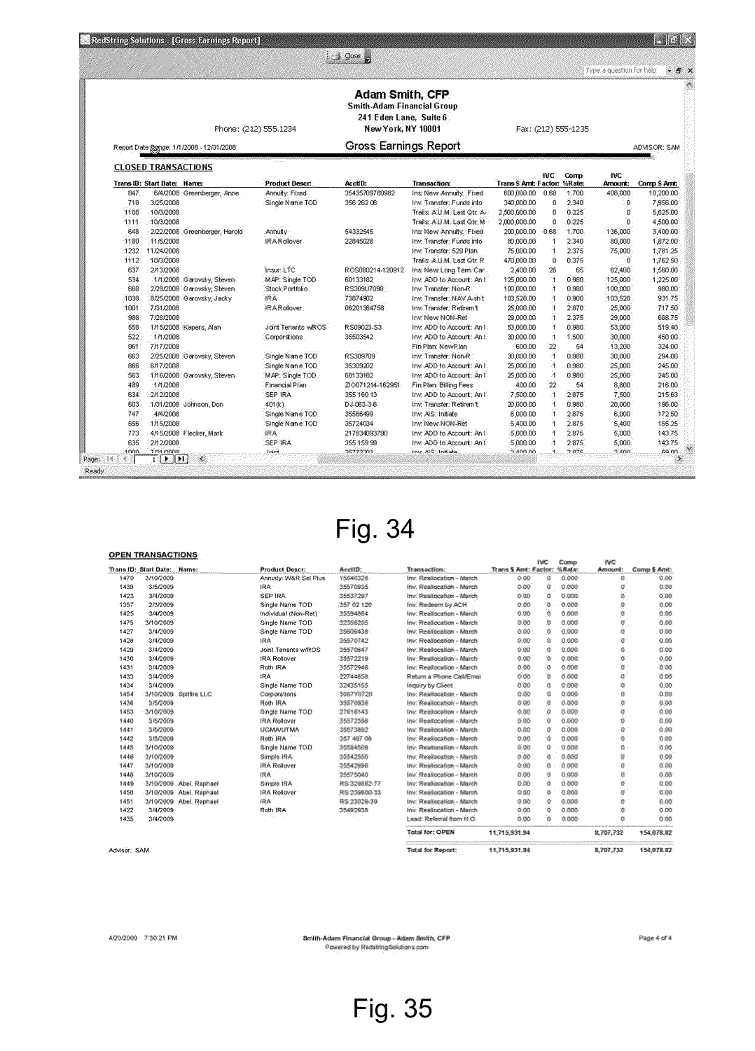

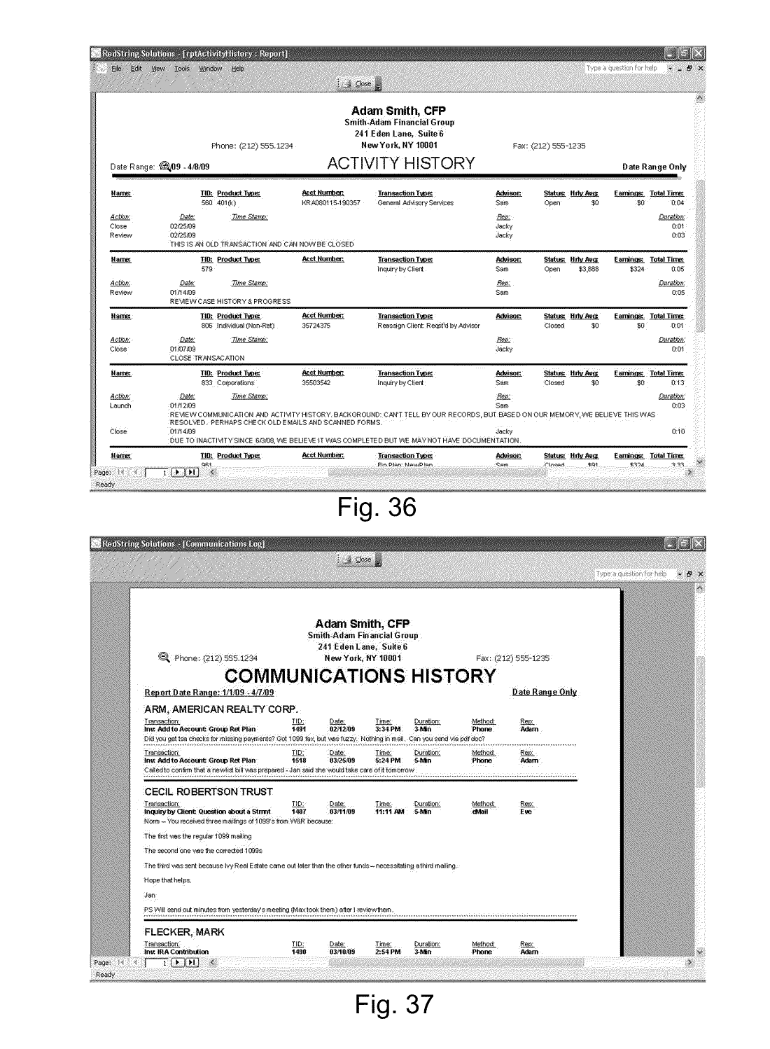

The information is automatically populated for the user based on the user's default settings in the reference tables: Case manager, Advisor, compensation rate, incentive volume credit rate, and the underlying task list with due dates and other assignations. The compensation amount and incentive volume credit is automatically calculated. This information is significant for generating many reports including but not limited to To-Do Lists (FIG. 28), Earnings Reports (FIG. 34), and Activity History Reports (FIG. 36). These auto-populated fields foster speed, accuracy and consistency in the way transactions are set up.

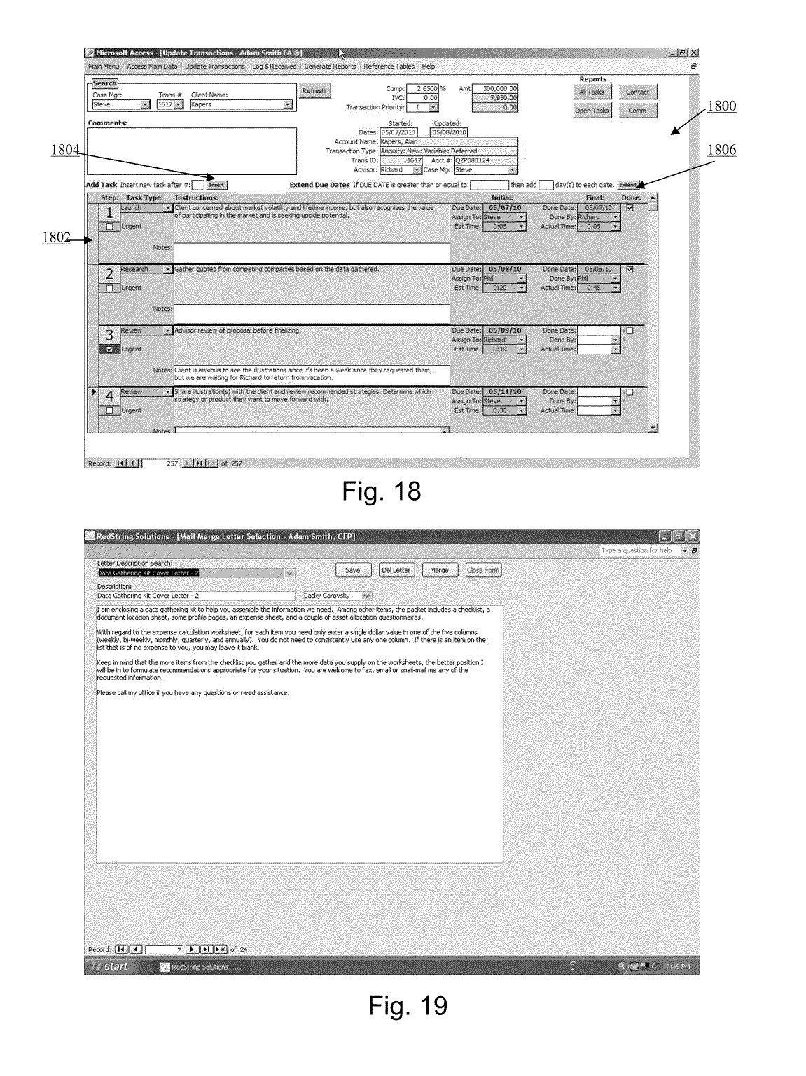

When user initiates a new transaction by selecting the “new” image element 606 in FIG. 6, the system automatically initiates generation of a further display image enabling user entry of transaction data. For example, as shown in FIG. 18, a task list display form 1800 corresponding to the selected transaction is accessed through the ‘Task List’ button. In this area, the user can update transactions and monitor their progress. This form 1800 displays the account name, account number, transaction type, transaction ID number, priority level, date initiated and the anticipated steps necessary to complete the transaction. The information on this form is important for generating reports. This form and its relationship with other forms have many benefits, including but not limited to To-Do Lists and Activity History.

This form 1800 provides step by step instructions in sequential order that are required for completing a particular task. In this example, the instructions refer to completing a type of transaction for a client. The task list form includes at least one task instruction record 1802. The task list includes a number of task instruction records corresponding to the number of steps required to complete the transaction. As shown in FIG. 18, there are four steps required and thus the task list includes four task instruction records. A task instruction record includes data fields that are automatically populated with task instruction data derived from at least one reference table including task information from a template that is built by a user using a template editor application of the system. Task instruction data fields that are auto-populated include (a) Step number, (b) task type, (c) task step description (‘instructions’), (d) due date, (e) estimated time for completing the task and (e) the staff person its assigned to. One case manager is assigned to each transaction, but the underlying steps can be assigned to different staff members. The steps are numbered and displayed in ascending order, with the ability to change the sort order in response to user selection of a sorting order image element. Steps can be modified or deleted. Additional steps can be inserted quickly using a hot button 1804 which generates a display image of task instruction data derived from at least one task instruction reference table. In the event that a user adds a task to the list of tasks being completed, the user may be presented with an option to automatically modify the template from which the instruction list was built to include the newly added task instruction data which would then be available in future instances of the task. Due dates can be extended easily also with a hot button 1806 which automatically initiates an executable procedure that modifies the due date in the transaction record and any other record accessing the transaction data. These features are significant because transactions often do not play out exactly as planned and allow the user to remain flexible and make adjustments as needed.

A task instruction record 1802 further includes data fields enabling the user to indicate if a task has been completed, the date of completion, the actual amount of time it took to complete it and the person who completed it. There is space allotted for notes below each task for allowing the user to document details which they may need to later reference. It is also a means for updating and communicating with other staff members who are also involved with the transaction. The task manager application automatically generates display images corresponding to error messages and warning labels appear when critical fields are left blank. This design helps the user remember to fill in data fields that supply critical information for various reports. It also fosters more complete and accurate reports. The task instruction record includes a data field enabling the user to designate an individual task as ‘Urgent’. This can be done with or without designating the entire transaction as ‘Urgent’. The benefit of this is draw attention to the urgency of a specific task.

The user can send a task and its respective date to a calendar application by clicking on the corresponding image element titled, ‘Calendar’. If it is an item that will repeat on an annual basis, the user can send the item to the client's list of important dates by clicking on the corresponding image element titled, ‘Imp Date’.

The user can print out a list of tasks pertaining to transactions by clicking on one of two ‘Report’ buttons. ‘All Tasks’ will show both open and completed tasks. ‘Open Tasks’ will show only open tasks. All notes and task descriptions are shown on the print-out. These reports are helpful to users who prefer to operate and run with paper copies of their task lists.

The client's contact information and communications floating windows are accessible through this form. This is much less disruptive than having to exit the Task List screen each time the user wants to communicate with the client, document communications, or reference such data. This makes workflow more seamless.

Additionally, the system generates a display image enabling the user to update various transactions. This form is very similar to the Task List form described above. However, this transaction update form advantageously allows the user to surf quickly between client records and transactions. Also, the user can modify the case manager, advisor, transaction amount, compensation amount, and priority level. This is a most useful tool for supervisors, practice managers or sole practitioners for updating and modifying transactions without having to go between client records. All other features available on the Task List form are also available on this form.

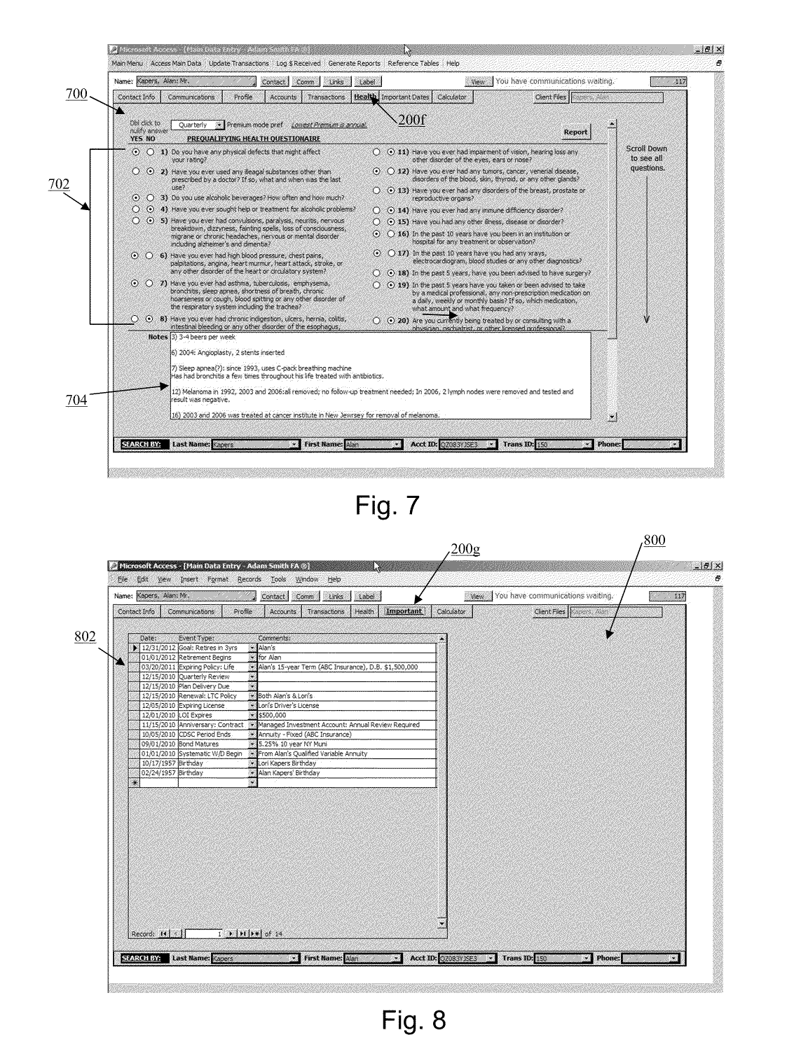

FIG. 7 is an exemplary display image of a health data form 700 that is generated by the system. The health data form 700 is displayed in response to selection of the health tab 200f from the MDE application. The form enables the user to selectively input and assign health-related data to a client via user selectable image elements. The health related data associated with the client may be used by the system or a third party application, for example, an insurance company. The form includes data representing a common health questions 702 asked by insurance companies. As questions shift over time, a user may selectively edit the questions listed in the health form using a form template editor. The system may automatically update the health question data list by initiating a search of a data repository of health questionnaire data, and include additional questions as they appear to become more common. The data included in this form assists a user who is a client Advisor with gathering relevant health information and identifying an insurance carrier that will rate their client favorably. The health data form 700 also include a health notes data field 704 that receives user-input data that may be associated with any of the questions listed in section 702 that may be helpful to the user in the process of applying for insurance, for example. Thus, sections 702 and 704 advantageously enables the user to gather unique information specific to the client which insurance companies require, including but not limited to medication type and frequency, description of an accident or medical condition, and reasons for hospitalization. This data is also necessary for completing various types of insurance applications. The client health data input by the user is stored in a client health data record in a client heath data table in the database. The values in the client health data record may be automatically used to populate a report as shown in FIG. 31 or fill-in a third party form accessible via a communication network such as an insurance questionnaire to minimize transcription errors between different applications.

Additionally, the system further advantageously generates a display image enabling a user to input client health data here that for use in assembling group census data. The group census data is selectively used for designing a group benefits program, including but not limited to a company retirement plan, group health, life insurance and disability insurance. This data can also be used to populate paperwork, reducing the amount of handwriting required, sparing time and error. Additionally, this data can be used to generate reports which help the user identify opportunities for additional business.

In another embodiment, the system advantageously accesses a name record in the system data and use various data from the Name Record to auto-populate various types of forms i.e. contact information, general & financial profile information, account information, health data, etc. The structure of the name record has a unique identifier associated with a particular data field and any form that requires data of that type can reference the unique identifier to auto-populate the field in another form generated by the system.

In a further embodiment, the MDE application includes a tab that enables the user to view and modify investment and insurance information associated with the client. Upon selection of the tab, the system generates a display image including inve<In future version (data tables already provided in back end), the front end will break the accounts screen/tab into two tabs: Investments and Insurance. Each tab will host a rich collection of data types (i.e. The Insurance tab would display insurance policy details, such as coverage, premium, policy #, coverage period, inflation rider, etc). The data will be updated with a daily feed from a third party data house.

FIG. 8 is an exemplary display image of an important dates form 800 detailing any important dates associated with the particular client. This form 800 is accessible by selecting the “Important” tab 200g from the MDE application. The form 800 includes a subform 802 having a plurality of date records corresponding to important dates associated with the client. An important date record includes a date field identifying the key date, an event identifier identifying the type of event which is important and a comments field that accepts user input via an input device to provide additional information regarding the important date. The dates stored in this form might be independent of existing transactions but are important enough to monitor. Such life events include but are not limited to CD and bond maturities, expiring Advisory licenses, expiring Letters of Intent, insurance policy renewals, expiring insurance policies, contract anniversaries, couples' anniversaries, and birthdays. Wherever appropriate, the user can send dates from other pages to be added to this list. In many areas where the program stores a date, the system automatically generates a display image prompting the user to add that date value and associated event identifier to an important date record to be displayed in the important date subform 802 of the important date tab 200g. This automatic prompting, which may occur in the form of a pop-up dialog box, reminds the user to consider whether this item belongs on the client's list of important dates, which further helps prevent relevant items from falling through the cracks.

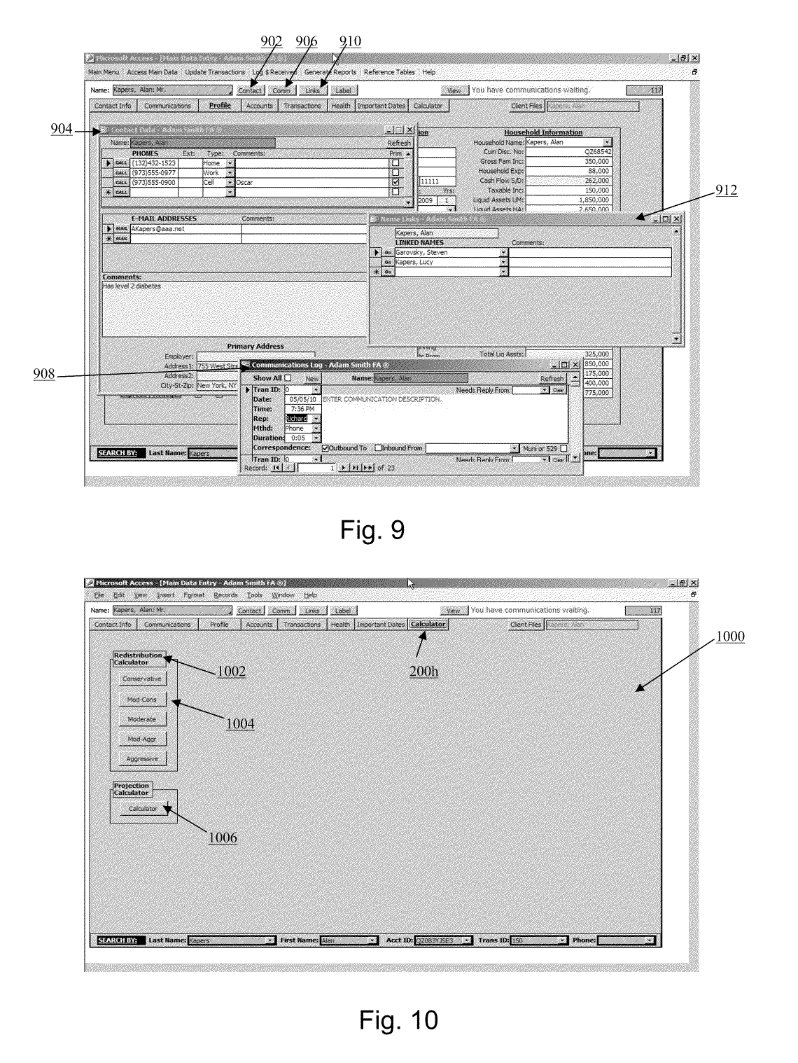

The main data entry application initiated by the system further includes a set of image elements that are displayed on each of the forms described above with respect to FIGS. 2-8. These image elements are hot buttons that, in response to user selection, initiate an executable procedure commonly employed by a user of the system. The hot button image elements include but not limited to at least one of ‘Contact’, ‘Communications’, ‘Links’ and ‘Labels’. All of these hot buttons open pop-up and floating windows include data fields associated with the type of hot button selected. These windows can be dragged or minimized. These windows remain on the screen until closed as the user jumps from one tab to the next. This allows the user to maintain access to the data and features of other tabs which they wish to use while moving between tabs. Thus the user has the flexibility to choose the type and amount of data visible on any given screen related to the corresponding Contact. The windows include the data fields associated with the application and are selectively modifiable by the user. An example of the display image including a plurality of floating windows is shown in FIG. 9. The MDE application maintains the hot buttons no matter which application tab is active. In response to selecting Contact button 902, the MDE application initiates an executable procedure that generates contact data display window 904. In the contact data display window 904, data representing a client's contact phone numbers, email addresses, and primary mailing address along with the ‘CALL’ and ‘Email’ hot buttons are displayed. In response to selecting Communications button 906, the MDE application initiates an executable procedure that generates communication data display window 908. The data displayed in the communication display window 908 is similar to the data shown in the communication tab as shown in FIG. 3. In response to selecting Links button 910, the MDE application initiates an executable procedure that generates links data display window 912. The data displayed in the links data display window 912 is the data shown in subform 208 in FIG. 2. In order to facilitate access to respective data types, windows 904, 908 and 912 may be displayed simultaneously enabling a user to selectively view and/or modify different date types at the same time. Additionally, although not shown in FIG. 9, in response to selection of the label button 914, a window including data labels used in mailings are displayed and a user can view, preview and modify label data to ensure correctness thereof

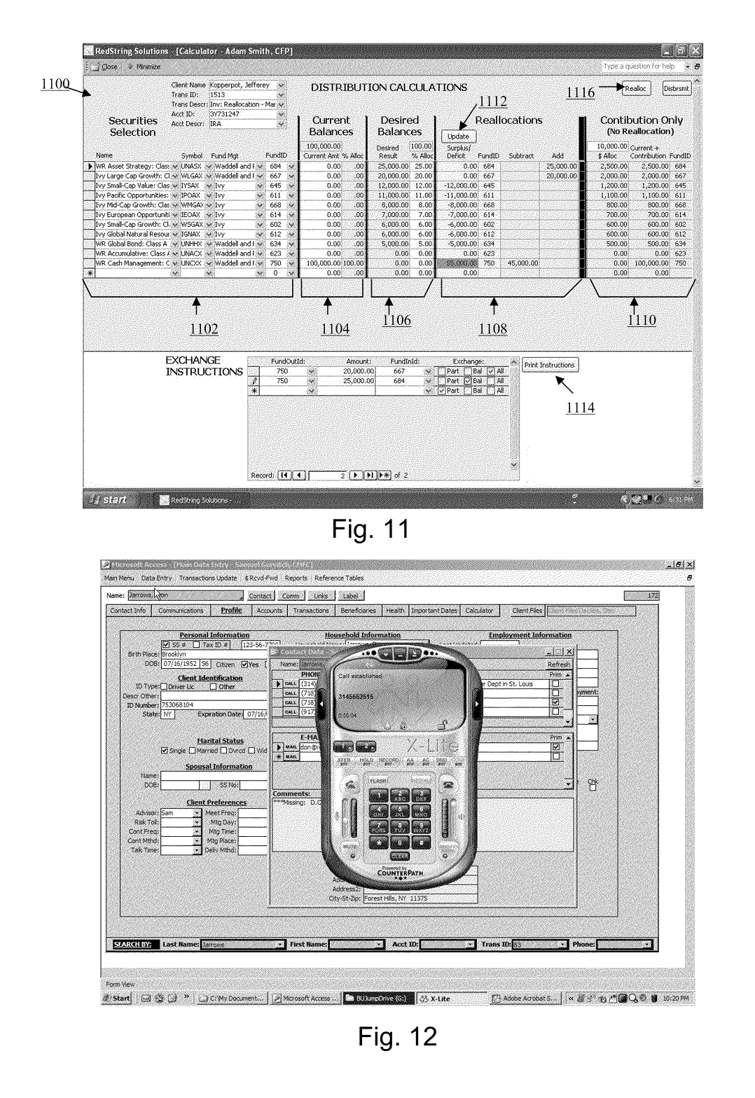

Upon entry of data corresponding to a particular client, the user is able to employ system functions to calculate portfolio rebalances and contribution allocations at a fraction of the time it traditionally takes. The redistribution calculator is shown in FIGS. 10 and 11 and the reports generated in response to redistribution are shown in FIG. 25-27. Without this calculator, the calculation for one account takes between twenty minutes and one hour. With this Calculator tool, it takes the user between one and five minutes. FIG. 10 is a display image 1000 of the calculator application implemented by the system. The calculator display image 1000 is generated in response to selection of the calculator tab 200h and includes a redistribution calculator application 1002 and a projection calculator application 1006.

The redistribution calculator 1002 includes at least one user selectable image element 1004 corresponding to a type of rebalancing algorithm to be implemented for the client. The system includes a plurality of different types of rebalancing algorithms which employs different calculation processes on different elements of client-specific data in order to determine how a client's portfolio is to be re-balanced or how certain assets in a particular portfolio are to be reallocated. Exemplary rebalancing models include (a) a conservative risk model, (b) a moderate-conservative risk model, (c) a moderate risk model, (d) a moderate-aggressive risk model and (e) an aggressive risk model. With the above models, a user securities from a set of securities listed in a reference table and assigns corresponding percentage of the total portfolio to the selected security within each model. Once defined, the model becomes the default for that risk level and when the End User selects the risk level via an image element on the calculator display window, the desired allocation is automatically populated into the data fields in the calculator. Alternatively, data representing a daily feed of the client's account balances will be automatically acquired for the corresponding account and the models will be automatically applied to the daily balances. In response to user selection of a particular image element, an executable procedure including the selected redistribution calculation algorithm is initiated.

The user can elect to use predetermined algorithms to automatically generates all of the recommended instructions for tasks to be completed for a particular rebalancing between five seconds and one minute after selection of the pre-loaded algorithm. The predetermined algorithms are based on type of financial portfolio model.

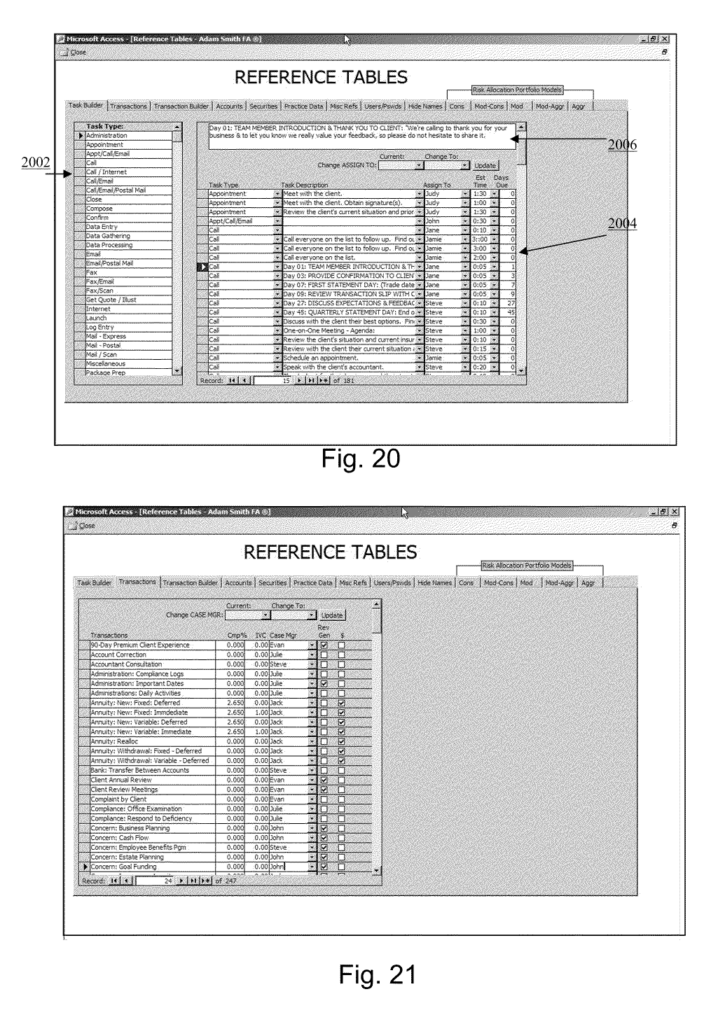

Additionally, the system allows the user to define the steps included in the redistribution calculation algorithm using a calculator editor application. The user is able to take advantage of his/her expertise in market valuation to define these steps and, using the calculator editor, assign this algorithm to an image element such that is may be rapidly employed for any and all clients. The user-defined image element is selectively displayed in the calculator display image 1000 and is available to the user who created the algorithm as well any other system user who has permission to access user-created calculation algorithms. A user may selectively modify default portfolio models using data stored in a calculation reference tables as shown in FIGS. 20-24.

In response to selecting the calculation image element 1006, the system automatically generates a calculator display image 1100 as shown in FIG. 11. The calculator helps with portfolio transactions that include but not limited to account contributions, redemptions, and reallocations or rebalancing. The calculator display image 1100 includes a securities selection section 1102 including a list of securities either owned by or sought by a particular client. The securities selection section includes individual security data records identifying the name of the security, the organization who manages the security, the symbol associated with the security (if publicly traded) and a unique fund identifier used by the system to ensure proper data processing thereof The calculator display image 1100 also includes a current balances section 1104 which includes a plurality of data fields identifying the current monetary balance for the particular security shown in a respective row of section 1102. Additionally, the current balances section 1104 includes an allocation percentage identifier identifying the percent of the total portfolio allocated to the particular security. A desired balances section 1106 is provided which includes user-modifiable data fields corresponding to a security in the securities selection section 1102. The data fields in the desired balances section include a desired monetary result data field and a percentage allocation data field. The user may selectively modify one of both values in the desired results section 1106. Alternatively, if the user modifies a value in only one of the two data fields, the system automatically fills in the data value in the other data field. Once the user determines specifies the desired balances, selection of an UPDATE image element automatically populates data fields in a reallocation section 1108. Therein, the user is presented with how the desired balances in the identified securities should be satisfied. The display image 1100 further includes a contribution only section 1110 that includes monetary values that are used for disbursing a sum of money (i.e. from a single cash position) as opposed to redistributing from existing positions; the disbursement is based on the portfolio model.

In another embodiment, the system includes a redemption calculator application. The redemption calculator application generates a display image including user fillable data fields that receive user entered values associated with amount of money to be redeemed from at least one respective account in the financial portfolio of the client. In response to entry of data representing a redemption amount, the system applies one of the above described risk models to automatically rebalance and reallocate monies between financial instruments in the portfolio to maintain a specified risk level. The system automatically generates instructions to be output which indicate amounts to be redeemed from the appropriate positions and what amounts are to moved from one position to another if necessary. This prevents a redemption from upsetting the proper/desired risk level allocation for a particular portfolio for the client.

By virtue of the drop down menus on the Calculator page, the user has the ease of selecting only one identifying piece of data that corresponds to a client, transaction or account to populate any all relevant information related to the calculation. This is particularly useful for generating a supplemental instruction form for share purchases, exchanges and redemptions. To generate this form, the user clicks on the ‘Print Instructions’ image element 1114. Each calculator has its own print button, ‘Print Instructions’.

In response to data entered by the user in the calculator data fields, the system is able to selectively generate reports including instructions on what steps need to be taken to ensure that the desired rebalancing is able to be realized. In order to maintain a record of the work product of the user, the system generates a Reallocation Worksheet as shown in FIG. 25. The reallocation work sheet report includes data input by the user while using the calculator as well as any steps executed by the calculator. This report advantageously allows the user to output a copy of the work product in electronic or paper form.

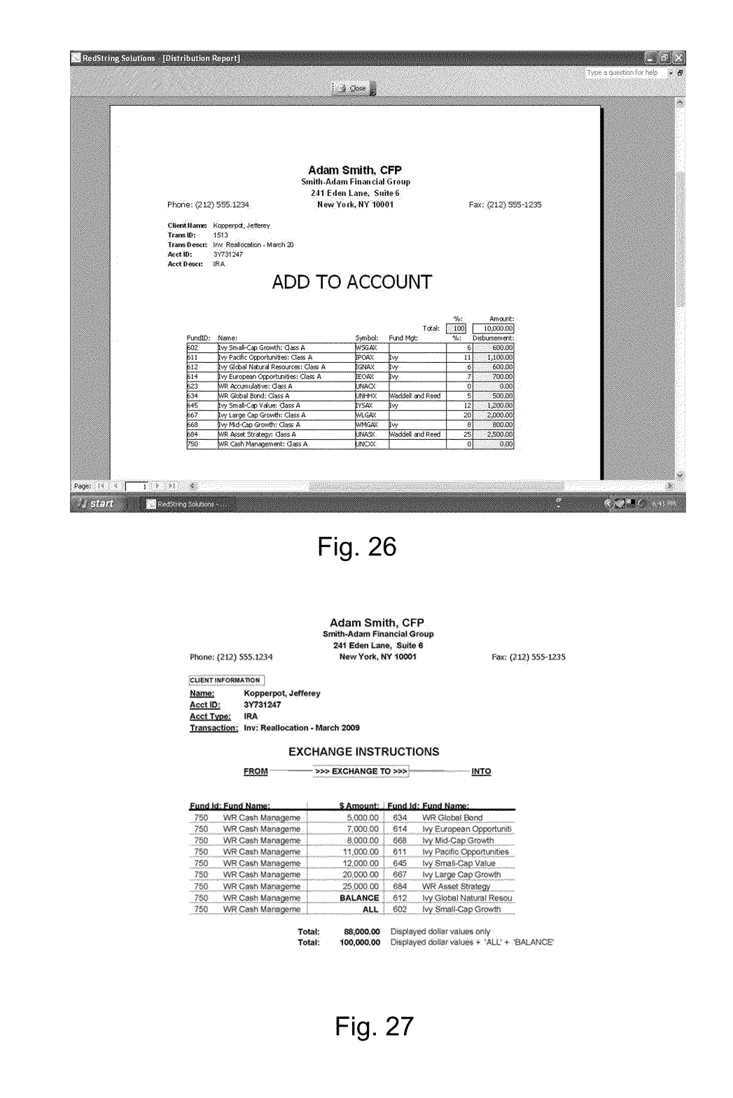

Additionally, in response to the data values entered into the calculator data fields, a report as shown in FIG. 26 is generated including data representing securities to be added to the client account and the amount of the securities to be added. Selection of a disbursement calculator image element initiates an executable procedure that executes an algorithm that automatically calculates an amount of funds to be invested into respective ones of a plurality of securities based on the allocation model percentage data. The report includes data representing a list of trade instructions that the user can provide to a broker-dealer's trade desk. This report includes data instructing the trade desk as to how the total amount of funds being invested are to be disbursed across the various securities: specifically detailing the amounts that are to be invested with each corresponding security.

The system further generates a rebalancing report as shown in FIG. 27 using the data values entered into the calculator data fields. This report includes data representing securities to be added to the client account and the amount of the securities to be added. Selection of a disbursement calculator image element initiates an executable procedure that executes an algorithm that automatically calculates an amount of funds to be invested into respective ones of a plurality of securities based on the allocation model percentage data. This report includes data representing a list of trade instructions that user can provide to a broker-dealer's trade desk. It instructs the trade desk as to how to rebalance or reallocate the portfolio including data identifying amounts of money that need to be redeemed/removed from the corresponding securities, and the amounts that need to added to the corresponding securities.

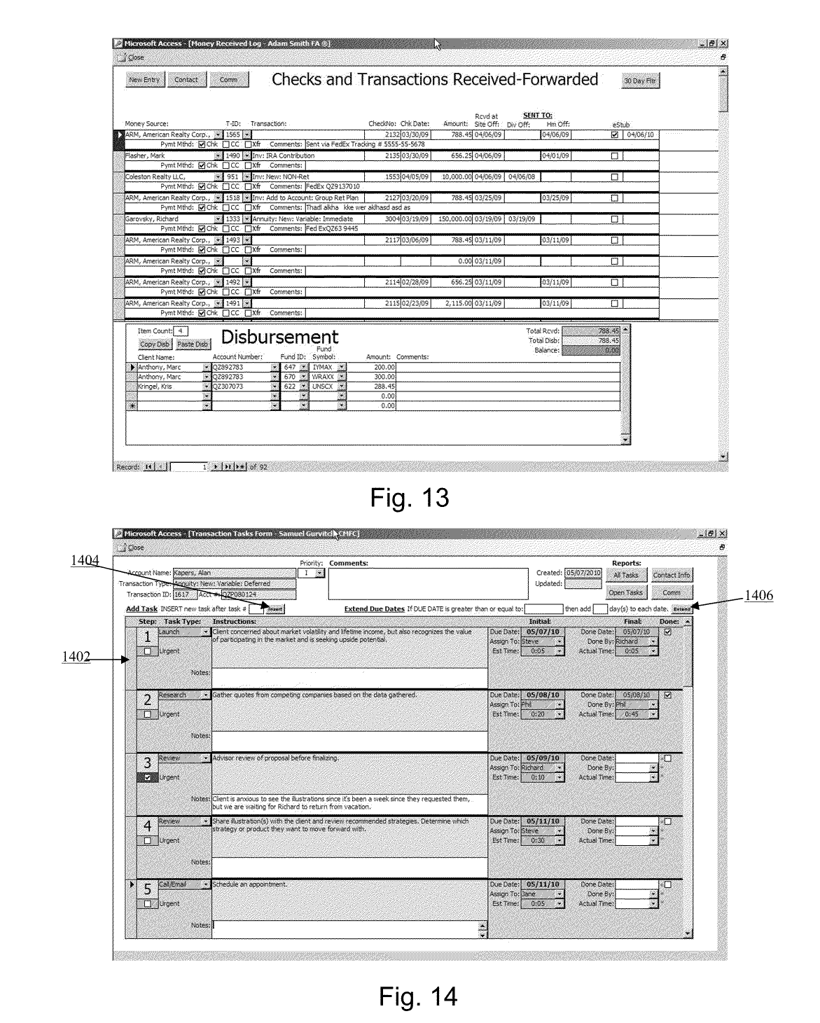

FIG. 13 is an exemplary display image detailing the business transactions associated with a particular client. Entries of all monies received and paperwork for all new business transactions are done here. The form includes a plurality of data fields enabling the user to define and customize the type of transaction for the client. Based on the data entered, a report is generated with the click of a button. This report is a daily log, “Money and Transactions Received and Forwarded.” Advisors are required by law to supply this log on a daily basis to their managing principal who is required to forward it to their Broker-Dealer. With drop down selections, the user is forced to choose from a list of transactions they have previously set up. This significantly reduces error and time otherwise involved with data entry. It also helps the user maintain proper documentation needed for other valuable reports. The user is prompted to provide information included but not limited to money source, TID, transaction type, product type, account number, transaction amount, check/credit card/transfer information, and dates received and forwarded to and from the different entities involved. There is also a ‘Disbursement’ calculator on the bottom half of the screen for the user to document specific breakdowns of a single transaction amount. This is significant for properly documenting individual transactions that involve the purchasing of multiple securities. Check boxes are available to indicate that the processing of the check, credit card, or transfer was confirmed. The default displays all entries in descending date order. There is a ‘30-Day Filter’ button to display only recent entries so the user has the option to reduce clutter. The filter can be turned off by clicking the ‘View All’ button. Hot Buttons for Contact Information and Communications pop-up windows are also provided. The user is able to disburse each transaction amount across different securities. Copying and pasting hot buttons allow the user to supply similar disbursement instructions for different clients and/or checks. This reduces duplicate entries and error rates, which saves time and improves compliance.

An exemplary task list display form 1400 is shown in FIG. 14. In this area, the user can update transactions and monitor their progress. This form 1400 displays the account name, account number, transaction type, transaction ID number, priority level, date initiated and the anticipated steps necessary to complete the transaction. The information on this form is important for generating reports. This form and its relationship with other forms have many benefits, including but not limited to To-Do Lists and Activity History.

This form 1400 provides step by step instructions in sequential order that are required for completing a particular task. In this example, the instructions refer to completing a type of transaction for a client. The task list form includes at least one task instruction record 1402. The task list includes a number of task instruction records corresponding to the number of steps required to complete the transaction. As shown in FIG. 14, there are five steps required and thus the task list includes five task instruction records. A task instruction record includes data fields that are automatically populated with task instruction data derived from at least one reference table including task information from a template that is built by a user using a template editor application of the system. Task instruction data fields that are auto-populated include (a) Step number, (b) task type, (c) task step description (instructions), (d) due date, (e) estimated time for completing the task and (e) the staff person its assigned to. One case manager is assigned to each transaction, but the underlying steps can be assigned to different staff members. The steps are numbered and displayed in ascending order, with the ability to change the sort order in response to user selection of a sorting order image element. Steps can be modified or deleted. Additional steps can be inserted quickly using a hot button 1404 which generates a display image of task instruction data derived from at least one task instruction reference table. In the event that a user adds a task to the list of tasks being completed, the user may be presented with an option to automatically modify the template from which the instruction list was built to include the newly added task instruction data which would then be available in future instances of the task. Due dates can be extended easily also with a hot button 1406 which automatically initiates an executable procedure that modifies the due date in the transaction record and any other record accessing the transaction data. These features are significant because transactions often do not play out exactly as planned and allow the user to remain flexible and make adjustments as needed.

A task instruction record 1402 further includes data fields enabling the user to indicate if a task has been completed, the date of completion, the actual amount of time it took to complete it and the person who completed it. There is space allotted for notes below each task for allowing the user to document details which they may need to later reference. It is also a means for updating and communicating with other staff members who are also involved with the transaction. The task manager application automatically generates display images corresponding to error messages and warning labels appear when critical fields are left blank. This design helps the user remember to fill in data fields that supply critical information for various reports. It also fosters more complete and accurate reports. The task instruction record includes a data field enabling the user to designate an individual task as ‘Urgent’. This can be done with or without designating the entire transaction as ‘Urgent’. The benefit of this is draw attention to the urgency of a specific task.

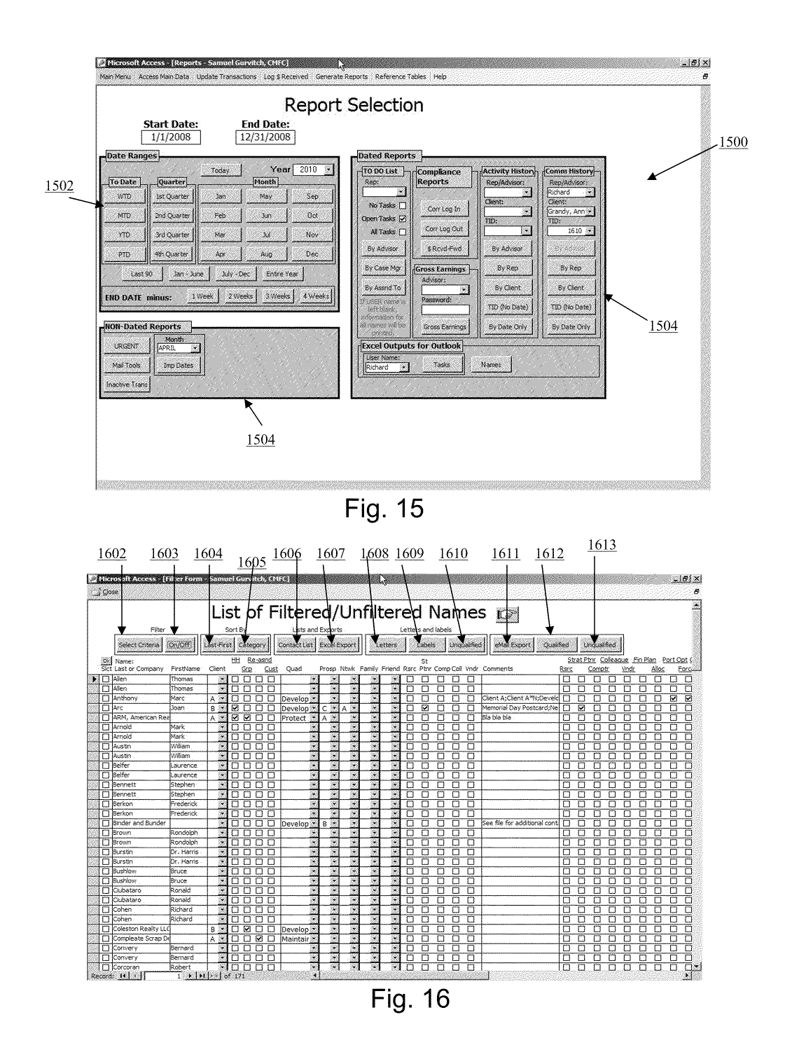

FIG. 15 is an exemplary report generation display image 1500. The system advantageously enables generation of a plurality of reports that quickly and comprehensively provide information about the particular client or sub-set of clients. Additionally, the system enables the user to generate practice-based reports including data corresponding to a plurality of clients and transactions which may be used to streamline and make the user's practice more efficient. FIG. 15 includes a plurality of user selectable image elements that correspond to particular executable procedures that initiate generation of a particular type of report. User selection of a ‘Reports’ button on the main menu bar shown in FIGS. 2-8 initiates execution of the report generation application and initiates the display 1500. The report generation display image 1500 enables a user to generate a report including data within a specified date range using image elements in section 1502. Additionally, the user is able to generate a “dated report” using image elements in section 1504 or “non-dated reports” using image elements in section 1506. Date sensitive reports include but are not limited to a To-Do List, Compliance Reports, Activity History Reports and Communication History. Non-date sensitive reports include but are not limited to Urgent Items list, Important Dates, Mail Tools and Contact Lists.

Reports generated by the system may generated in response to user selection of an image element on a particular display screen corresponding to a type of report to be output. Alternatively, reports may be automatically generated by the system in response to trigger events including a user specified date and or time. Additionally, a trigger event may include completion of a particular task or transaction or in response to receiving a communication message from a user or from a third party who is granted access to the system. Trigger events may be built into the firmware of the system or may be selectively modified by a user.

In the event that a user desires a particular type of dated report, the user may select a custom date range using the image elements in section 1502. To reduce the amount of time spent on manually providing date ranges, a set of convenient hot buttons were created to represent the most common date ranges the user would need. Selection of a particular image elements results in the report generation application automatically using a predetermined date or range of dates when querying the database for relevant data. Predetermined date image elements includes week-to-date, month-to-date, year-to-date, period-to-date, first quarter, second quarter, third quarter, fourth quarter, image elements corresponding the months of the year, Last 90 Days/Trailing Quarter, Week-to-Date, Month-Date, January-June, July-December and Entire Year.

An exemplary dated report corresponding to a “To-Do List” is show in FIG. 28. This report includes data representing a list of incomplete transactions and/or incomplete tasks for open transactions associated with at least one client. To-Do Lists for an individual employee or for all employees of the practice are automatically and instantly generated. This report accesses the various data tables in the system database to acquire data representing tasks and transactions that are associated with a particular client that require handling on a given day or within a specified date range. The default displays today's date to spare the user of having to select a date range whenever they are looking for only that day's task list. In one embodiment, the To Do list includes all of the tasks and transactions for a particular client and identifies which user the task/transaction is assigned. In another embodiment, a modified report including only tasks assigned to a particular user is produced. This modified report may also include information regarding other users who are required to perform tasks associated with the task assigned to the user who is the subject of the report.

The To Do list report includes predetermined report formats including generating reports ‘With Open Tasks Only’, ‘With All Tasks’, and with ‘With No Tasks’. ‘Open Tasks’ displays transactions with incomplete tasks that are due by the date specified or within the date range specified. ‘All Tasks’ displays all tasks, including both incomplete and completed tasks, for all active that are due by the respective date(s). ‘No Tasks’ displays only the transactions without listing their underlying tasks. This list is primarily used as a transactions status report displaying the case manager responsible for the transaction and the number of tasks that are due and/or past due for each transaction. The level of urgency and importance of each transaction is also displayed on all formats. There user selectable image elements in the form of check boxes associated with each task and transaction with a column header marked ‘Done’ to indicate that the item was handled. There is also an empty box next to each priority box that designates a place for the user to write in a number to indicate the sequence in which they plan to handle the list of items.

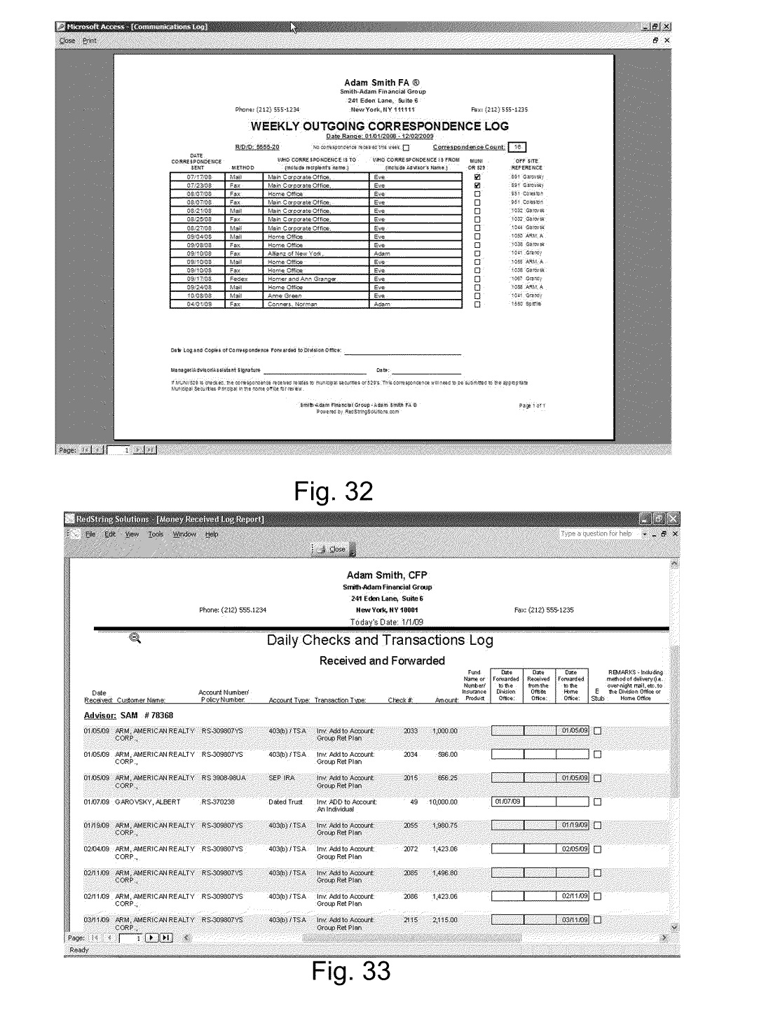

Another type of report generated by the system are compliance reports which are mandatory reports that Financial Advisors submit to help managing principals and broker-dealers regulate sensitive activities. Activities that are included within compliance reports include correspondence with the public (both incoming and outgoing), and processing new business (i.e. client service requests, transactions involving the handling of a check or credit card, etc.). Exemplary compliance reports are shown in FIGS. 32 and 33. Most of the information that is required on these reports has already been entered elsewhere within forms of the MDE application and thus is automatically accessible by the report generation application of the system which automatically generates the report on these reports for the user. The user is spared the task of having to gather and re-enter any and all information that need to be included on these reports. This saves the user a great deal of time, and fosters consistency and better accuracy.

The outgoing correspondence report of FIG. 32 includes data representing the Advisor's Broker-Dealer name, the Advisor's name, address, phone number, fax number, office ID number, and the date range of the report. Below that header is a list of all of the correspondences recorded within the date range selected. The list show the date the correspondence was sent or received, the method of delivery (Mail, FedEx, Fax, etc.), who the correspondence was from and who the correspondence was to, and identifies the type of transaction associated with the correspondence. Additionally, reference information is displayed next to each listed correspondence, indicating the client and transaction ID that the correspondence relates to.

This monies received report of FIG. 33 includes data representing the Advisor's Broker-Dealer name, the Advisor's name, address, phone number, fax number, office ID number, and the date range of the report. Below that header is a list of all transactions that are considered “new business” which require forms to be forwarded to a supervisory office after being received at an “off-site” or branch office. For each transaction, the following information is displayed: Advisor ID#, Date Received, Customer Name, Account Number/Policy Number, Account Type, Transaction Type, Check #, Amount, Fund Name or Insurance Product, Date Forwarded to the Division Office, Date Received from the Off Site Office, Date Forwarded to the Home Office, E-Stub (to indicate scanned & electronically processed), and Remarks (to indicate method of delivery to Division/Home Office, i.e. overnight).

The report generation application of the system also generates reports as shown in FIGS. 34 and 35 that show a list of all transactions, and the revenue and incentive volume credit generated by them. All of the rates and factors used to calculate these figures is also displayed. The significance of this report is the instantaneous ability to view a report showing where an Advisor or an entire firm stands in terms of revenue within the specified date range. Closed transactions are displayed first. Then all Open transactions are displayed. Each are tallied separately so that the Advisor/Firm can easily how much revenue has already been generated and how much revenue can potentially be received if all of the open transactions in the pipeline follow through to completion. A total of revenues from all closed and open transactions are also calculated and displayed for informational purposes. Access to this feature of the report generation application may be access controlled to protect the privacy of each Advisor who shares this program with other Advisors and/or employees. Thus, access to this feature may require the user to enter username and password data in specified data fields that are generated when a request to access the earnings generation report is received by the system.

FIG. 34 is an activity history report that includes data representing all activities done within the specified date range by or for the specified user or client. The activity history report is generated by the report application accessing client information, communication, linking, task and transaction data tables to obtain data values corresponding to at least one of a unique client identifier or user identifier to retrieve records of activities performed within a particular date range. Each activity is shown corresponding to a client, transaction, office rep, date done, time done, duration, compensation, and hourly dollar average. Totals are tallied for time spent on each client and transaction. Total compensation for all listed transactions and total averaged dollar per hour for the report are shown as well. This report advantageously assists in employee productivity tracking by identifying time spent on each client and/or transaction as well as the compensation earned to help the user determine if an appropriate amount of time and resources were devoted and if the compensation was worth it. Important business decisions and business planning strategies could be based on this information. The report also enables the user to instantaneously track the activities of all persons associated with the office. That information can be used for determine if office staff are completing a satisfactory number of tasks in a given period and spending the appropriate amount of time on assigned tasks. It can also be used to determine the average time that needs to be allotted for any given transaction or task for proper planning and allocation of human resources. Through remote access, this report also enables a user to see what was being handled (and determine what was not being handled) within the specified time period, to help keep a pulse on their business no matter where they are without having to request updates from their staff or hold conference meetings. This saves a great deal of time. Fashioning such an organized and informative report in an instant at any time is a powerful tool for any business owner. Instead of spending time in meetings or assembling such reports, the Advisor can spend more time on bigger picture items, such as prospecting for new business, meeting with clients, research, strategy development and so forth.

A further type of dated report includes a communication history report shown in FIG. 37. This report includes data representing all communications held within the specified date range by or with the specified user or client. This report is populated via data entered or obtained in the data fields of the subform of the communication tab. An example is, data representing a telephone call that was placed in response to selection of the CALL button adjacent to a particular client contact number is stored as a communication record with a client identifier, a user identifier and including data identifying the date of the communication. The system automatically queries the various data table to identify types of communication for particular clients or users along with the date that the communication occurred. All matching values are automatically used to populate the communication history report. Each communication is shown corresponding to a client, transaction, office rep, method of communication, date done, time done, duration, and the content of the communication. Totals are tallied for communication time spent with each client and on each transaction or by the specified user. A user is able to instantaneously review all incoming and outgoing communications between the Advisor's office and their clients, prospects, vendors and strategic partners. Communication with the public is a sensitive and heavily regulated issue in the financial services industry and the system advantageously produces a communication history report to comply with all regulations. Proper documentation and reporting is extremely helpful in clarifying what was communicated, which can be essential in resolving issues. It is also helpful for reference purposes to be able to review what might have been forgotten, including promised deliverables and time tables as well as data gathered and identified opportunities for new business.

In another embodiment, the report generation application generates a report including data representing all communications having a type designation (i.e. incoming, outgoing, etc) and which include data representing a type of response required for the type of communication. The system automatically queries the communication data table to identify communications of a particular type and which require a particular response and outputs data values matching this criteria in this report. This report displays all inbound calls and emails for which a reply is needed or has been requested. This allows for easy identification of communications that require more immediate attention and help the user be responsive to their contacts. This report helps distinguish these time sensitive communications from all others that are included in the communication history report.

Referring back to FIG. 15, the report generation application enables the user to select image elements in section 1506 that correspond to non-date specific reports. The image elements within section 1506 in display window 1500 correspond to different types of reports that are non-date specific. This means the reports include data that is not specifically tied to a date or range of dates. Selection of an image element in section 1506 initiates execution of a report generation procedure that keys on a type of data in the database that is not date-specific.

An exemplary non-date specific report is an urgent items report shown in FIG. 29. The data values displayed or output by the reporting application include any entries that include an indicator identifying the data entries as “urgent”. This report lists all tasks and transactions that were deemed Urgent by the user(s). This helps an office quickly devote its resources to the most urgent issues at hand by instantly assembling all urgent items on a to-do list. Urgent items are usually time sensitive but can get neglected if not flagged and otherwise lost in the mix with all other non-urgent items. On this report, Urgent items stand alone and advantageously provide the user with knowledge of tasks or transactions that must occur substantially soon. Alternatively, another type of non-date specific report includes an important date report which automatically outputs data values corresponding to important dates that are associated with a particular client. This report instantly generates a list of all important date items that the user(s) listed in the corresponding data entry form for each client. This helps the user easily keep track of all dated items by simply selecting the month and clicking on the “Important Dates” button. Each appointment item on the computer allows the user to indicate date, time, location and notes about the meeting.

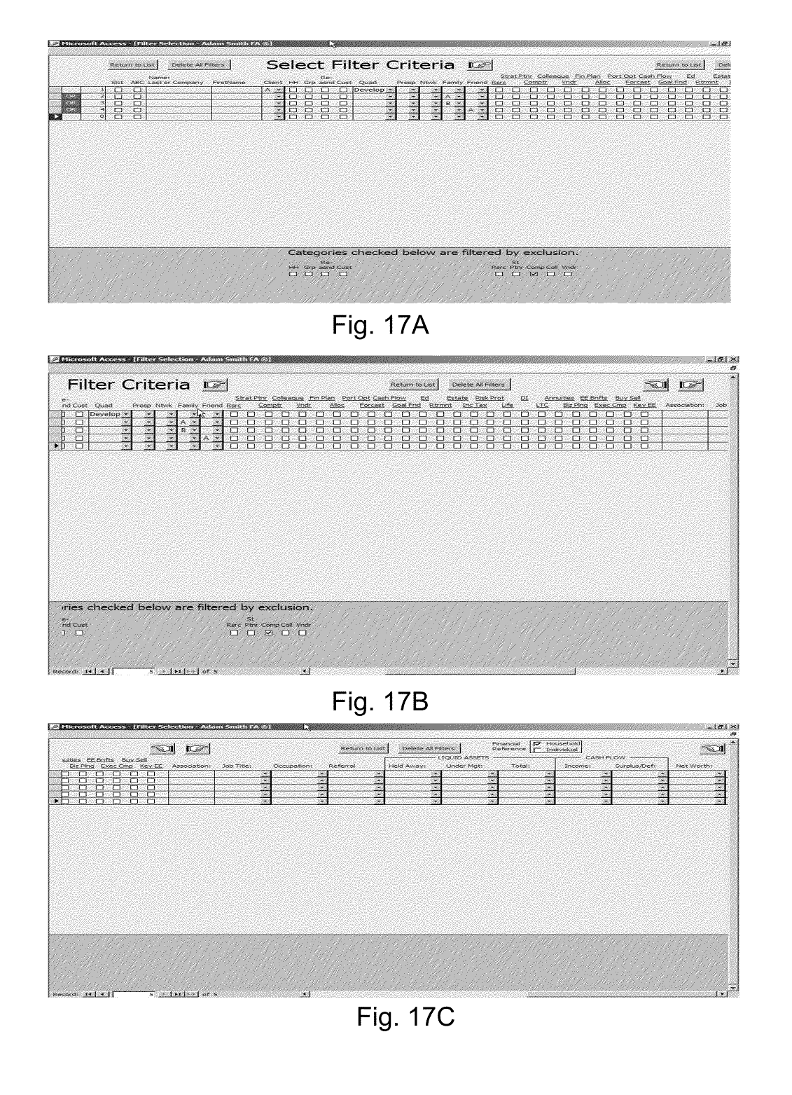

FIGS. 16 and 17a-17c include exemplary display images generated by the mail tools application of the system. These display images enables the user to quickly generate mail merges, contact lists, address labels and blast emails. Mail merges are notorious for requiring a great deal of time and effort in putting them together. The user can quickly generate a list of their intended recipients by selecting the criteria using the program's “Filter Criteria” buttons as shown in FIGS. 17a-17c.

FIG. 16 is an exemplary display image of the results of an executed filtering task using the mail tools application window shows in FIG. 17A-C. FIGS. 17A-C, while show as three separate display screens may be a displayed in a single display window. FIGS. 17A-C allow the user to define the filter criteria to be implemented during a filtering task; Each row in the display image corresponds to a particular client. The image includes a plurality of columns enabling the user to selectively classify the client in the row according to certain criteria. The following list includes the types of filtering criteria available to a user of the system. Image elements and/or user modifiable data fields and drop down boxes are presented within the display windows of FIGS. 17A-C enabling the user to determine which filtering criteria to apply.

Select: If you user wants to individually filter specific names that are otherwise unrelated

ABC: Rapid filter for Names that are categorized as ‘A’, ‘B’ or ‘C’ Client, Prospect, Network, Family or Friend.

Name: Filters for a specified name.

The Ranking of ‘A’ through ‘E’ is applied to ‘Client’, ‘Prospect’, ‘Network’, ‘Family’ and ‘Friend’. It is a means for indicating importance based on the User's Criteria (i.e Client does a lot business with the FA, Contact refers a good deal business their way . . . )

HH: If this name is a primary Household.

Grp: If this name is a group (i.e. organization, business entity, etc)

Reassigned: If the name is a client that was previously an “orphaned” account (meaning no Advisor) and then re-assigned.

Cust: If this is a Custodial account

Quad: Refers to ‘Quadrant’ denotation for denoting the level of cultivating desired by the user for a particular name using the following four designations: Develop, Protect, Monitor, Maintain.

RSRC: For filtering those names denoted as Resources; a resource would be an entity the user relies on for information

Strat Ptnr: For filtering names denoted as strategic partners

Comptr: For filtering names denoted as competitor

Colleague: For filtering names denoted as colleague

Vndr: Vendor—For filtering names denoted as vendor

The following criteria realate to client concerns as indicated in their Profile: FinPlan (Financial Planning), Alloc (Asset Allocation), PortOpt (Portfolio Optimization, Forecast (Wealth Forecasting), Cashflow, GoalFnd (Goal Funding), Ed (Education funding), Rtrmnt (Retirement Funding), Estate (Estate Planning), IncTax (Income Tax), RiskProt (Risk Protection), Life (Life Insurance), DI (Disability), LTC (Long Term Care), Annuities, BizPlng (Business Planning), EEbnfts (Employee Benefits Program), ExecCmp (Executive Compensation Program), BuySell (Buy-Sell Agreements), KeyEE (Key Employee)

Association: For filtering names denoted by a particular association, such as Fellow Chamber of Commerce Member, Rotary, etc.)

Job Title: For filtering names by Job Title

Occupation: Filters by client occupation

Referral: For filtering names that came from a specified referral source

The following are based on the dollar value ranges selected for either a household or an individual: Held Away <assets held away that are not under the management of the End User>, Under Management <assets held away that are held under the management of the End User>, Total <total assets owned by client>, Income, Surplus/Def <cashflow surplus or deficit; Net Worth <client's net worth>. Household or Individual financial information by indicating with a check-mark

The mail tools application display image includes a plurality of user selectable image elements at the top of the screen that enable the user to initiate execution of certain system functions. Image elements 1602 enable a user to selectively assign a filter criteria for use in filtering a list of client information to generate a filtered client list. Image element 1603 enables a user to selectively activate or deactivate the user of the filter criteria specified by the user. By selecting image element 1604 the user is able to sort through at least one of the filtered list of clients or unfiltered list of client in descending order by their last and first names. Image element 1605 enables the user to sort by a particular type of category that may be assigned to a client. By selecting image element 1606, the system automatically generates a report listing including client contact data for the selected or filtered list of clients. Alternatively, if no filter is applied, the system automatically generates a complete listing of contact data associated with all clients. Selection of image element 1607 results in the system automatically exporting a data file in a particular data file format including client contact information. Image elements 1608-1610 are part of the mail merge application and enable a user to automatically use the filtered client data as part of a letter or label creation procedure that creates letters and/or labels addressed to the selected clients using the filtered client contact data. If, upon completion of a letter or label mail merge, certain clients that were selected during the filtering process did not receive a letter or label, a user can select the unqualified image element 1610 to automatically generate a list of clients from the filtered client list that are missing a critical data value in a contact information data field (i.e. apartment number or zip code). Selection of any of image elements 1611-1613 initiate execution of the email blast procedure enabling a user to automatically create an email including email addresses for clients in the filtered client list.

FIGS. 17a-17c are exemplary display images of the filtering application initiated in response to selecting the filter criteria image element 1602 in FIG. 16. The filter tool enables the user to generate a list of contacts that match the criteria provided by the user. Data corresponding to each contact record can be used as a means of categorizing. Such data includes but is not limited to: the type of contact (i.e. Client, Prospect, Strategic Partner, Friend . . . ), financial profile (i.e. net worth, income, liquid assets, liabilities, financial concerns . . . ), general profile (i.e. gender, age, state of residence . . . ), time sensitive events (i.e. expiring contracts, maturing CDs, birthdays, anniversaries, expiring licenses), contact rankings (i.e. A, B, C, D, E, and/or Develop, Protect, Monitor, Maintain), referrals, and more.

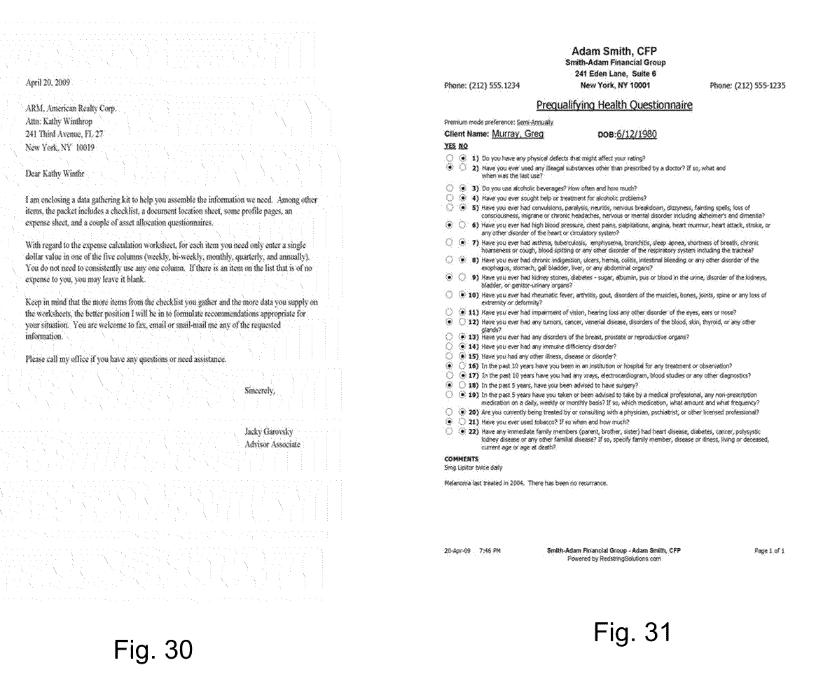

The mail tools application includes a display screen with at least one user selectable image element that corresponds to an executable procedure for producing a type of mail merge output. An image element corresponding to an executable procedure for generating a letter mail merge initiates generation of a display as shown in FIG. 19 which enables the user to create or modify a template letter to merge with a selected list of contacts that are stored in a contact information data table of the system database. Upon creation of a new mail merge template or modification of an existing mail merge template, a user selects a activation button within the display image which merges the contact data from the database into a plurality of letters as shown in FIG. 30. Clicking a “Letters” button automatically initiates generation of a display image including a plurality of different type of template letters. The template letters may be stored in a repository and include a letter type identifier that enables the system to automatically recall the stored letter in response to user request. Using a drop down menu, the user selects the template letter they wish to use. They can modify the letter and save it. New letters can be easily added here by typing them directly in the message section or by pasting a pre-typed message there, providing a title for the letter in the “Title” section, and clicking the “Save” button. Once the template letter is selected, to complete the mail merge (merging the recipients list with the letter), all the user needs to do is click on the “Merge” button. Their message will automatically be formatted into a standard letter format while strategically placing the recipients' addresses to line up with a window envelope. This saves the user from getting involved with the letter formatting process. Furthermore, the user can select the author of the letter from a drop down menu. The name and title of the author will be appropriately placed on the letter below the message.

Another mail tool provided by the systems is the label generation application for preparing address labels for all of the recipients of a particular mailing. The program instantly generates a report to match a standard format for mailing labels. To do this, after the list of contacts have been selected using the filtering application described hereinafter with respect to FIGS. 16 and 17a-c. An image element corresponding to an executable procedure for generating a set of labels is provided. The user selects the “Labels” button under “Letters and Labels”. The mailing labels are generated and include client contact information associated with the filtered clients and which is derived from the client contact data table.

A further mail tool advantageously enables the user to quickly identify missing data from a set of selected clients. The mail tools application automatically weed out addresses that have at least one data field with a null value that is identified as critical. If a required address field is left empty for a contact, a letter and/or label will not be generated for them. To help the user rectify those situations, the user can generate a list of contacts whose designated primary address is missing a piece of critical information by clicking on the “Unqualified” image element under a “Letters and Labels” tab. This tool saves the user time by sparing them of the experience of discovering bad addresses after the fact (after the mail merge or mailing labels were generated) and enables them to quickly identify any outstanding address issues.

The mail tools application also enables the user to selectively query the user contact data table to derive data corresponding to email addresses for a selected or filtered set of clients. Upon selection or filtering of client data to produce a selected set of clients, the mail tool application initiates an email blast executable procedure which automatically exports a set of client email address into a text file that can easily be opened by the user and the contents of which can be copied into an address line in an outgoing email generated by the user. Alternatively, the email blast executable procedure automatically initiates generation of a new email and inserts the email address data into an address data field in the new email. For example, the email address data is automatically inserted into a blind carbon copy data field to ensure privacy of the respective clients that are part of the selected set of clients. To see a list of all contacts without an email address, the user clicks on “unqualified”. To a list of all recipient who have emails to be includes in the mass email, the user clicks “Qualified”.

The system further includes an editor application that enables a user to selectively define data types for different data items that are used throughout the various forms generated by the system. The editor application provides reference tables used by the system to define client specific data, such as transactions, tasks, accounts, securities and practice data. The display images generated by the editor application are shown in FIGS. 20-24.

FIG. 20 is an exemplary display image of the task builder application that allows the user to create new tasks for use as default tasks associated with a particular client. Additionally, the task builder application enables a user to selectively modify existing tasks stored in a task repository to tailor a task to a particular practice management style. The task builder application display window includes a candidate list of tasks 2002 from which a user can select a task type. Upon selection of a task type a new task record is listed in a row of the task list 2004. Each task type is further qualified by a task description which is selectively entered by a user or automatically populated with a default task description that is associated with the task type. Additionally, the task list enables a user to selectively assign the particular task to a particular user as a default value by selecting from a candidate list of users via a drop-down menu. Additionally, the task is associated with a time value identifying the estimated amount of time required to complete the task. This time value maybe user specified or automatically populated with a default value associated with the task type. The task may also be assigned a value corresponding to a specific date on which the task must be completed after the task has been assigned to a user. When a user selects a task from a row in the task list, a task description appears in the description window 2006 to provide the user with the complete task description and allows the user to selectively modify the description of the selected task. This is where task types and task description combinations are created with default settings, including the assignation, estimated time and days until due.

FIG. 21 is an exemplary display image of the transaction list which enables the user to add, modify or delete transactions that may be associated with the clients. Default settings for these transactions types are also made here, including but not limited to the default case manager and an indication as to whether the transaction is going to generate new business traffic for the business and/or generate immediate earnings.

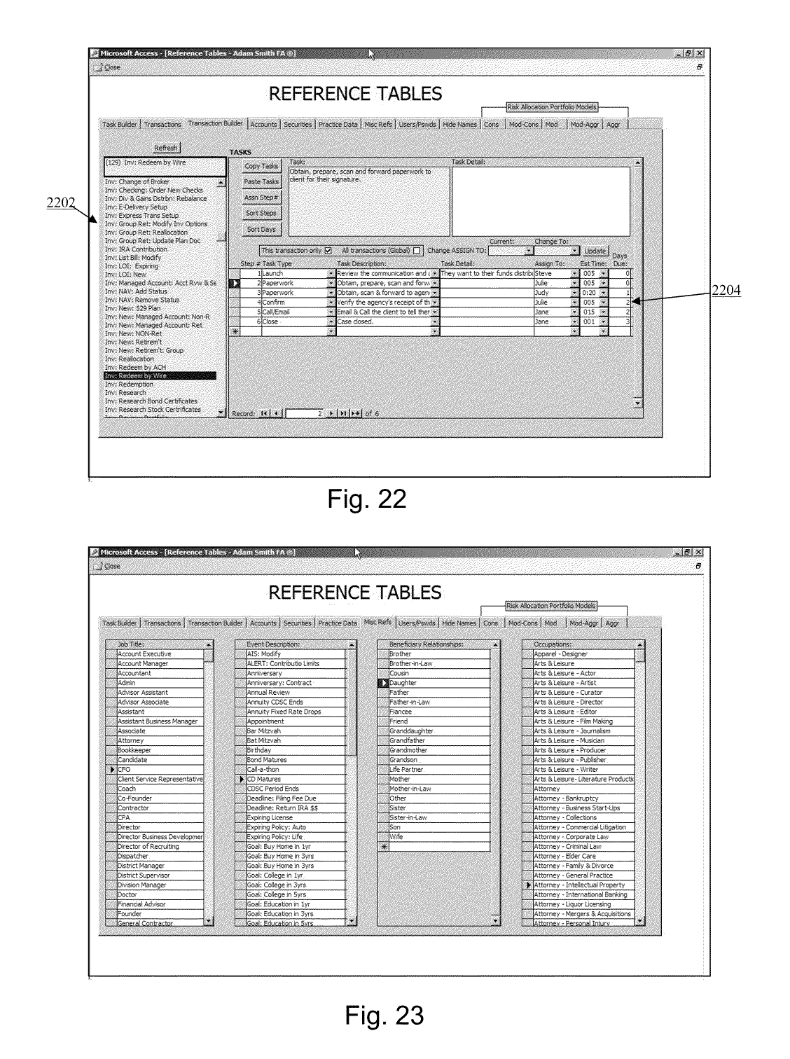

FIG. 22 is an exemplary display image of the transaction builder application which advantageously enables the user to specify the steps required to perform a particular type of transaction that is selected from the transaction list of FIG. 21. This is where the underlying task lists are built for each transaction type along with default assignations, estimated time allotted for tasks and due dates. A candidate list of transaction types is listed in display window 2202. A user selects a transaction type from the list in window 2202. For each transaction type, the user can specify a set of task types that are associated with the transaction type using task assignment section 2204. The task type is assigned a step number defining the order in which the task type is to be formed. The task type includes a task description derived from the task builder application in FIG. 20 and which is stored in a task repository after creation thereby. The ordered task type automatically includes any information previously defined including a user to which the task is assigned for completion, an estimated time value and a value identifying when the task is due to be complete after the initial assignment of the task.

FIG. 23 is a display image of a set of reference information that may be assigned to a client profile including a job type indicating the type of job the client has, beneficiary relationship information for identifying the nature of the beneficiaries relationship to the client and an occupation type data including a candidate list of occupation types for classifying a client. Additionally, the display image includes a candidate list of event descriptions

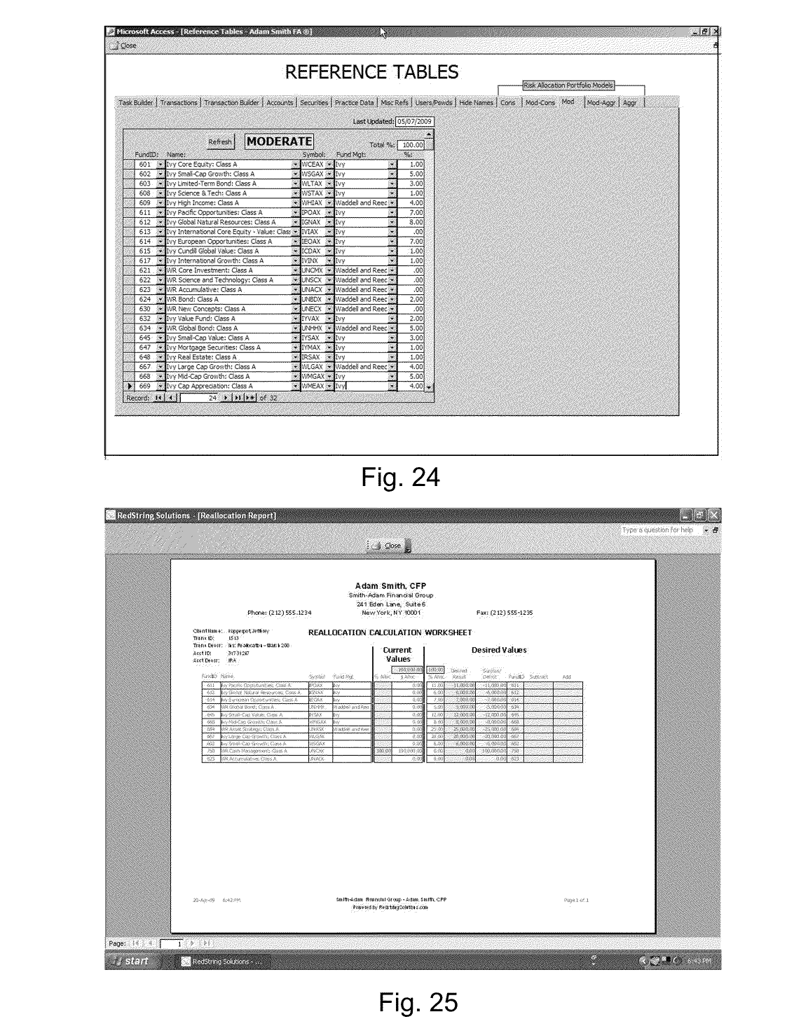

Additionally, the editor application includes a reference table corresponding to various risk allocation profiles. These risk allocation profiles are used by the calculator application to project and rebalance client account distributions automatically in response to user selection and implementation of a rebalancing algorithm. The editor application enables a user to access risk allocation reference tables that correspond to a conservative risk allocation strategy, a moderate-conservative risk allocation strategy, a moderate risk allocation strategy, a moderate-aggressive risk allocation strategy and an aggressive risk allocation strategy. For purposes of example, a display image corresponding to the moderate risk allocation strategy is shown in FIG. 24 and will be described. It should be appreciated that the structure of the table and types of data in the table are similar but differ based on a risk value associated with the type of data. The moderate risk allocation reference table includes a plurality of records associated with different financial instruments or accounts that have a risk value that is substantially moderate. Each record includes a fund identifier, a fund name, a fund symbol and fund management data. When a user activates the calculator application and selects a moderate risk allocation rebalancing profile, the drop down menu is populated with the names of the funds that are listed in this reference table. This enables the user to selectively specify subsets of moderate financial instruments to the client and decide how client assets are to be allocated between the various funds. Alternatively, the moderate risk allocation reference table may contain a specific subset of moderate risk rated financial accounts or instruments that are preferred by a particular user and which are automatically applied according to user specified rebalancing rules when the user selects the moderate risk allocation profile in the calculator application. The other risk allocation reference tables include similar types of data except that the instruments/accounts listed therein correspond to a different risk rating, for example conservative, aggressive, etc.

Additional reference tables are provided which provide candidate data values for populating certain data fields throughout the application. An account names reference tables include a list of candidate account names and/or types can be added, modified or deleted. Modifications include setting default account privileges associated with the account name and/or type. A securities reference table is provided and includes a candidate list of securities for use in the portfolio models described above with respect to FIG. 24. Securities can be added, modified or deleted from this list. Critical information for each security is stored here, including the security's name, trading symbol and share class. A reference table that specifies user information including user practice information is provided and enables the system to automatically brand each report and/or display screen with the user practice information. A reference table listing all user names and passwords is provided. This is where the list of all users in a particular office are listed. User names are added, modified and disabled here. This is the area of the program where administrative privileges are granted to users or revoked. Employee status is also indicated here. A reference table enabling the user to selectively determine types of data to be hidden from display is also provided. The purpose of this feature is to help reduce unwanted clutter in reports and drop-down menus while allowing the user maintain complete historical records.

As discussed above the system includes a plurality of user selectable image elements that initiate generation of commonly used forms. For example, at the top of all MDE screens is a Tool Bar for initiating the various pop-up windows described earlier. This provides for quick access to the pop-ups' corresponding information while working in many of the various forms. Additionally, the system includes a search window on each form that enables the user to search for a contact record by Last Name, Company Name, First Name, Account ID, Trans ID, or Phone Number. Typing in data automatically finds the nearest matching value. While the user is able to create new client record data, previously entered client records are easily imported using an import wizard application during the installation of the executable application. Moreover, the system advantageously interfaces and synchronizes with other applications' databases, such as Microsoft Outlook in response to user selection of a particular synchronization image element.

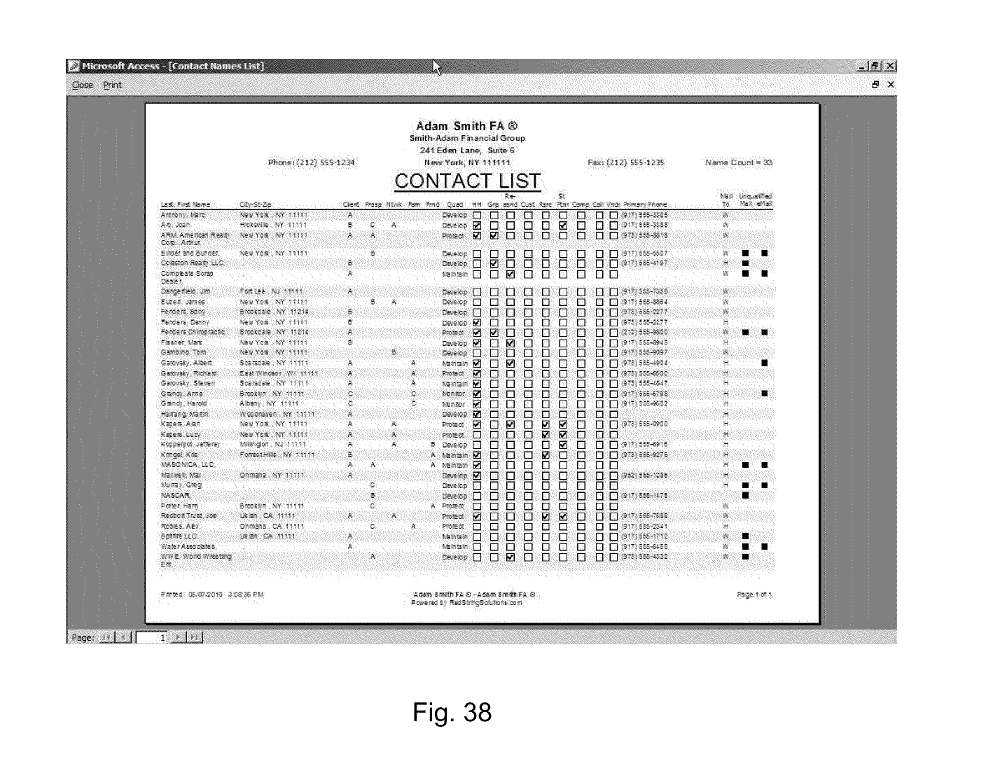

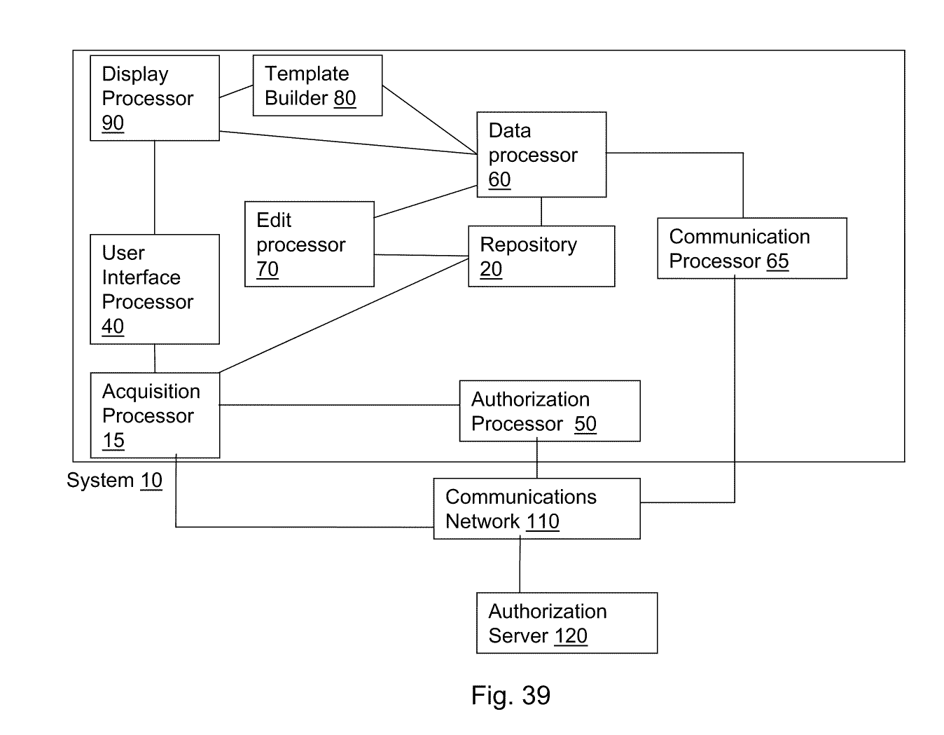

FIG. 39 is a block diagram of the automated practice management system 10 described above with respect to FIGS. 1-38. The block diagram of FIG. 38 is an alternate embodiment of the system described above. This embodiment includes a plurality of specific purpose hardware devices that operate in response to executable instructions hardcoded into electronic circuitry. All processors are electrically coupled to one another and include ROM modules that store operating instructions directing operation of the specific system functions. The system 10 includes a data processor 60 that drives system function. The processors described below are able to implement the algorithms described throughout the specification and figures in order to perform all of the features described above with respect to FIGS. 1-38. The data processor 60 operates at least one of automatically and in response to user command to initiate a particular function. The data processor implements at least one redistribution algorithm enabling recalculation of a client portfolio.

The system 10 further includes an acquisition processor that interfaces with a user input device to acquire data enter by the user via the user input device. The acquisition processor is electrically coupled to the user interface processor which generates a plurality of display images via the display processor 90 enabling user input of client data. The various display images generated by the user interface processor are described above with respect to FIGS. 1-57. The display images include at least one of user-fillable data fields, selectable image elements and candidate data items associated with a particular data type. The acquisition processor acquires the data entered by the user and provides the client data to a repository 20. All client data is stored in the repository. While the repository is shown herein as being local, it should be noted that the repository may be remotely located and accessible by a communication network. The client data in the repository 20 is selectively accessible by the data processor 60 and used during the implementation of at least one redistribution algorithm.

A template builder 80 is connected between the display processor 90 and the data processor 60. The template builder 80 enables user definition of a plurality of different types of data items that are used by the system 10. For example, the template processor 80 enables the user to selectively define the steps and/or instructions for a particular redistribution algorithm to be implemented by data processor 60. Alternatively the template builder 80 provides for the creation of additional forms which are client and/or practice specific and which may be included as further tabs displayed by the main data entry application. In a further embodiment, the template builder 80 enables the user to define particular image elements that appear on particular forms or universally on all forms which initiate a particular executable procedure driving system operation.

The system further includes an edit processor 70 that enables the user to selectively edit any data item that is used by the system. For example, the edit processor 70 enables the user to selectively modify, change or add a new type of client transaction or task. In response to operation, the edit processor 70 assigns unique identifiers to the data items being edited and provides them to a look-up table in the repository 20 enabling the data processor 60 to parse the look-up table for use during auto-population of particular data fields.

A communication processor 65 is electrically coupled between the data processor 60 and a communication network. The communication processor facilitates communication between the user and a particular client. For example, in response to selecting an image element entitled “call”, the data processor 60 signals the communication processor 65 to initiate a particular communication operation, for example, a telephone call to a user. Alternatively, in response to selecting an image element entitled email, the communication processor 65 is able to initiate an executable procedure resulting an email being composed and including the relevant client information in the email. Moreover, the communication processor 65 enables the user to generate a communication log to track the nature of all communication between the client and user. Communication processor 65 initiates operation of a memo application that converts communication data in a first form (i.e. voice) to a second form (i.e. text). The communication data is automatically added to the client record and stored in the repository 20.

System security is controlled via an authorization processor 50. The authorization processor 50 receives user authorization data via the acquisition processor 15 and compares the received data to a source of authorization information. The authorization processor 50 compares authorization data to locally stored authorization data source enabling quick access to system functions. Alternatively, the authorization processor is connected, via a communication network 110, to an authorization server 120. At predefined intervals, authorization processor 50 initiates a remote authorization check to determine if the user is complying with access terms such as those defined in a client license agreement. The user entered authorization information is communicated via the communication network and provided to the server 120 which compares the data with stored authorization data to determine if the user is in compliance. Upon determining that a user is in compliance with a license agreement, the authorization server communicates and authorization message to the system 10 to enable the user to access the system.

FIG. 40 includes a plurality of types of data tables including the types of data values stored in the data table which are stored in the system database and accessible by various system applications as described above.
tblNameData—Client names, categories and association
tblRelationsData—Names associated with the client that aren't independently listed
tblPhoneData—All phone numbers associated with client
tblEventsData—List of events and their dates (e.g. Policy reviews and renewals, expirations, birthdays, anniversaries, etc.
tblAltAddressData—All residential addresses, past and current
tblEmailData—All email addresses
tblCommunicationData—Information related to communications
tblClientAcctData—Client account information (e.g. product type, account number, balance, last update)
tblMoneyRcvd—Who money was received from, amount, date, check number
tblMoneyDisbData—Money received distribution information
tblNameLinkData—Links names that are in the system to client
tblHealthData—A conglomeration of all the most common questions found on a health questionnaire
tblClientData—Client profile information (e.g. employer information, preferences, goals, spousal data, SS number, monies, personal financial profiles, family data
tblHouseholdData—Household financial profile
tblBenefAcctData—List of accounts that have beneficiaries and who the beneficiaries are
tblAcctTransData—Account transaction information (e.g. advisor, case manager, transaction and account numbers, Amount, Incentive credits, etc.)
tblTaskData—The tasks that relate to a transaction (that's already been created, not reference tasks)
tblInsuranceData—A collection of information relating to insurance policies which includes benefits, coverage, costs, deductions and various other specifications

FIG. 41 includes a plurality of data tables including a list of data values stored in the respective data tables that are used in creating at least one of a task and transaction to be associated with a client.
tblTaskTypeRef—A list of short descriptions to be applied to tasks
tblTasksRef—A list of generic task which include a Task Type field, who task is assigned to by default, estimated time to complete
tblTaskTimeRef—A list of common elapsed times
tblTransactionRef—A list of all transactions with default case manager, compensation and other miscellaneous values
tblTransactionTasksRef—A combination of transactions and their associated tasks, including due dates. This provides the underlying reference source of tasks when creating a new transaction for a client.

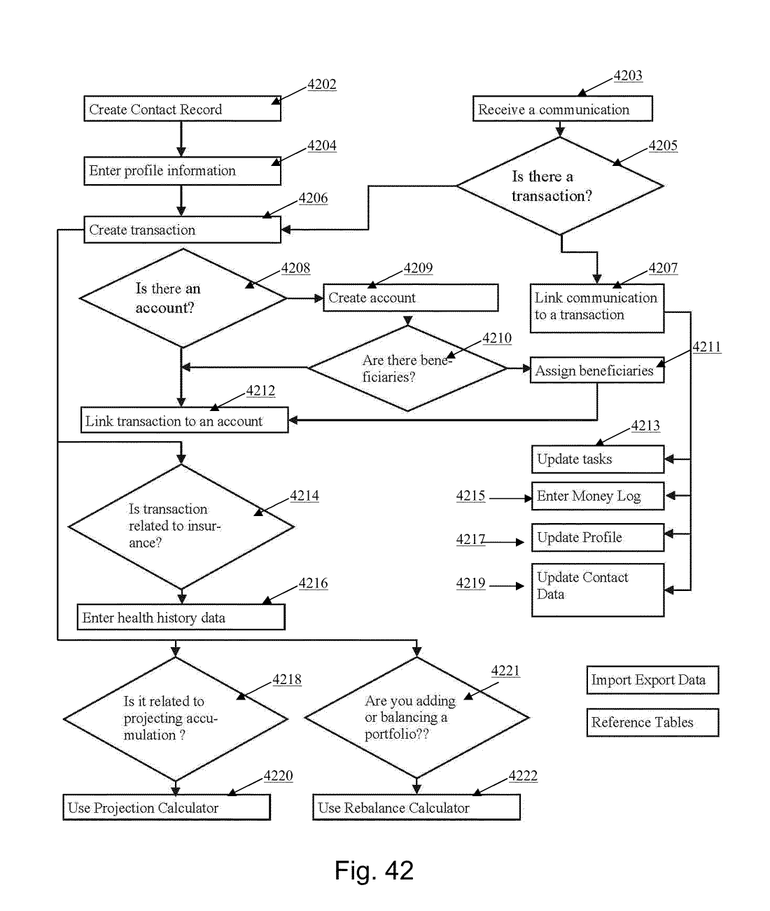

FIG. 42 is a flow diagram defining an algorithm for controlling system operation. System operation may begin at step 4202 whereby a data processor initiates display of a display image enabling a user to create a contact record for a client. The display image generated in step 4202 includes at least one data field defining at least one characteristic associated with a client. Upon creating the contact, contact data is stored in a data table in a repository and is selectively accessible at a later time. An example of step 4202 is described above with respect to FIG. 2. At step 4204, a data processor generates a display image including at least one data field for receiving user input that enables a user to enter and specify profile information for the client created in step 4204. The profile data entered in step 4204 is stored in a data table in a repository and is selectively accessible at a later time. An example of step 4204 is described above with respect to FIG. 4.

As the object of the system is to manage financial information associated with clients using profile data to help the client achieve a particular financial goal, step 4206 includes generation by a data processor of a display image including at least one data field for receiving user input associated with a transaction to be performed on behalf of the client. The transaction created for the client may include a plurality of different types of financial transactions and includes at least one task associated therewith that defines instructions for performing the transaction. An example of the operation of step 4206 is shown in FIG. 6. Once a transaction is created, the system automatically checks if there is an account associated with the transaction in step 4208. If the query returns a negative result, then the system proceeds to step 4209 and generates a display image including at least one data field that enables the user to create an account to be associated with the transaction created in step 4206. The account creation in step 4209 allows a user to define at least one characteristic associated with the account including but not limited to account type, account number and account access privileges. The account data generated in creating an account is stored in a client account data table and is selectively accessible at a later time. An example of step 4209 is described above with respect to FIG. 5. Once the account is created in step 4209, the system queries whether or not the newly created account for the client includes any beneficiaries in step 4210. If there are determined to be beneficiaries associated with the account, then in step 4211 the data processor generates a display image including at least one data field enabling the user to enter beneficiary data to be associated with the account created in step 4209. The beneficiary data entered in step 4211 is stored in a beneficiary data table which is selectively accessible at a later time. An example of beneficiary assignment performed using the system may be found in FIG. 5. Once beneficiary data is assigned, the system, in step 4212, automatically links the created account with the transaction created in step 4206. An example of this operation is described above with respect to FIG. 5. Additionally, if the query performed in step 4210 yields a negative result indicating that no beneficiaries are to be assigned to the account, then the system proceeds to step 4212.

Referring back to step 4206, the system facilitates the processing of multiple types of transactions for clients. Upon creation of a transaction in step 4206, the system automatically queries whether the transaction is related to procuring insurance for a client or modifying an insurance policy for a client in step 4214. If the system determines that the transaction is insurance related, then the system data processor, in step 4216, automatically generates a display image including at least one data entry field enabling the user to enter health related data associated with the client which is stored in a health data table and is accessible by a third party insurance provider to obtain data representing an insurance quote for the client. An example of the operation of steps 4214 and 4216 is described above with respect to FIG. 7.

Once again, referring back to step 4206, the system automatically queries whether the transaction is related to projecting wealth for the client in step 4218 and, if so, the system automatically initiates execution of a calculation application that enables the user to selectively enter data representing client financial information and calculate a projection using the client financial data according to type of risk allocation profile that is preferred by the client. This automatically generates a series of records that allow a user to present various options to the client to determine what actions are to be taken in order to achieve a desired financial goal. The system also automatically checks if the transaction created in step 4206 includes adding or balancing a portfolio for a client. If this is the type of transaction created in step 4206, then the system automatically initiates execution of a calculation application that enables the user to automatically rebalance and redistribute client assets between various client accounts using a type of risk allocation model in step 4222. An example of steps 4220 and 4222 is described above with respect to FIGS. 10 and 11.

In another embodiment of system operation, a communication processor receives a type of communication from a client in step 4203. The received communication is automatically parsed to determine if the communication includes transaction information in step 4205. If the communication includes transaction information, the system operation continues as described above at step 4206. Additionally, if the communication includes transaction information, the communication is automatically linked to the transaction in step 4207 which enables generation of a complete history of all communications and their nature. The linked transaction information is stored in a transaction data table in the system database is selectively used in step 4213 to update a list of tasks associated with the client. Additionally, if the communication includes funds transfer information, the linked transaction and communication are used to update a log including all monies received by the user for the particular client step 4215. The linked transaction data is also automatically provided to update the client profile data table in step 4217 and the client contact data table in step 4219. Thus, the system is able to automatically parse and breakdown all communications into individual data segments in order to update any previously entered client information as well as create an activity and transaction history for the client.

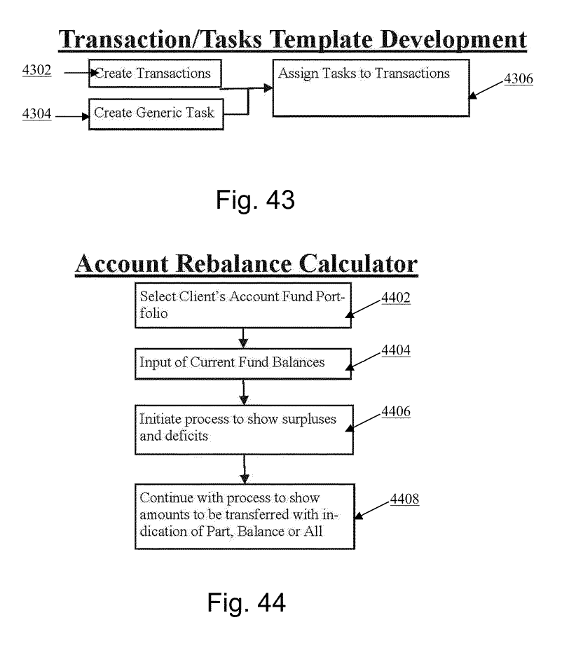

FIG. 43 is a flow diagram defining an algorithm for controlling system operation. The system advantageously enables the user to create at least one transaction to be associated with a client in order to aid the client in achieving a financial goal. This algorithm provides additional instructions regarding step 4206 in FIG. 42. In step 4302, the system automatically generates a display image including at least one user selectable image element enabling the user to create a transaction template that is selectively used when implementing step 4206 in FIG. 42. The user selectable image elements enable the user to specify the transaction type. The display image in step 4302 includes a candidate list of transaction types that are derived from a transactions reference table stored in a repository. An example of step 4302 is described above with respect to FIGS. 18-22. Once the user selects the transaction type from the candidate list of transactions, the system, in step 4304, generates a display image enabling the user to create at least one task that is to be performed in order to complete type of transaction selected. The display image includes at least one data field enabling the user to enter task description data, task identifier data, task assignment data, and at least one task characteristic including data representing the time required to complete the task. Upon creation of at least one task in step 4304, the system enables the user to selectively assign the created task to the selected transaction in order to generate transaction template data which is stored in a template repository. The transaction template data is selected when the user creates a transaction in step 4206 in FIG. 42 and provides the user with data representing all tasks required in order to complete the transaction.

FIG. 44 is a flow diagram defining an algorithm for controlling system operation. The algorithm in FIG. 44 includes the steps associated with the calculation application used in rebalancing a client's portfolio. In step 4402, the system generates a display image including user selectable image elements associated with at least one client and at least one client portfolio associated with the particular client. Upon selection of a particular portfolio, data stored in a client portfolio table is automatically loaded into calculation data fields which are displayed to a user. The display image includes user-modifiable data fields that allow the user to input a data value corresponding to the current fund balance. The user is able to selectively assign a risk allocation type to the particular portfolio that automatically selects a set of financial instruments and accounts that are associated with the risk allocation type. The risk allocation type is used in generating a set of desired balances data that is determined in accordance with a risk allocation value associated with the risk allocation type. In step 4404, the system automatically applies the risk allocation type and risk allocation value to the data stored in the client portfolio to derive values corresponding to fund surpluses and deficits. Generation of fund surpluses and deficits includes, for each financial instrument in the portfolio identifying a value for that instrument that is required to meet the risk allocation type and displays an amount of money associated with that financial instrument and if that amount is sufficient based on the risk allocation type and value. Once these values for individual financial instruments are displayed, the system automatically displays amounts from the individual instruments to be transferred therebetween in order to achieve the desired risk value associated with the risk allocation type. The system automatically rebalances the portfolio according to a risk allocation type using a risk allocation value to modify financial instrument value data in the client portfolio.

In another embodiment, upon determining that values of certain financial instruments are to be modified, the system automatically generates transaction types including transaction tasks which are presented to the user in order to accomplish the rebalancing. These transaction types and tasks may be automatically input into a users TO DO list notifying the user to perform the particular transaction type and provide information to the user as to why the particular transaction is being performed.

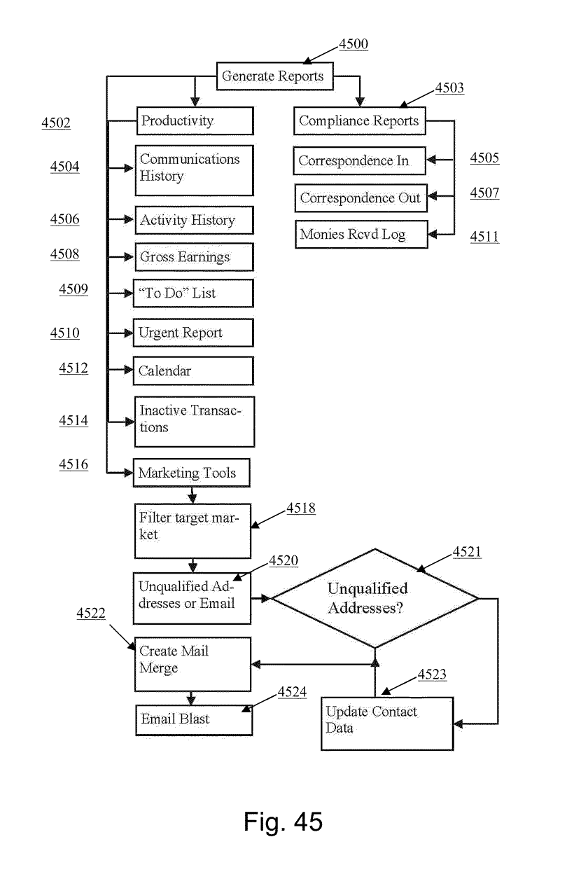

FIG. 45 is a flow diagram defining an algorithm for controlling system operation. This algorithm details the operation of the report generation application of the system. A user selects an image element in a display window that initiates execution of the report generation application in step 4500. The report generation application enables a user to selectively determine a type of report to generate. A user is able to generate a productivity report in step 4502 or a compliance report in step 4503. All report types generated via the report generation application may be at least one of displayed in a display window on a display device, incorporated into a message in a particular data format which is selectively communicated to a third party, and output to an output device such as a printer. The data items included in the various report types are derived from the various data tables described above and which are stored in the system database.

In response to selecting generate a productivity report in step 4502, the report generation application generates, for example, a plurality of user selectable image elements in a display window that each correspond to a type of productivity report. In step 4504, a user can selectively generate a communications history report which includes data representing all communication related to at least one of a user, client, contact, transaction or within a specified date range. This report can include communication data that has occurred within a specified data range or time period. An example of this is shown in FIG. 37. In step 4506, a user can selectively generate an activity history report which includes all communications, transactions and tasks performed on behalf of a particular client. Additionally, the activity history report includes data identifying an amount of money earned associated with the particular activity listed in the report. An example of this report is described above in FIG. 36. In step 4508, a user can selectively generate a gross earning report for the user's practice. An example of this is described above with respect to FIG. 34. In step 4509, a user can selectively generate a report including data representing tasks, transactions, communications that need to be performed. An example of this is described above with respect to FIG. 28. In step 4510, a user can selectively generate a report including urgent tasks and/or transactions that need to be taken care of substantially immediately. An example of this is described above with respect to FIG. 29. In step 4512, a user can selectively generate a calendar report that includes task/transactions/communications and other related information for all clients on specific dates. An inactive transaction report may be generated in step 4514 which includes data representing transaction for at least one client that are not currently active at a particular time.

In step 4516, the user can initiate execution of the mail tools application as described above with respect to FIGS. 16 and 17A-C in order to generate a marketing report. Upon execution of the executable procedure initiating generation of a marketing report, the user is presented a display window including user selectable image elements enabling filtering of clients and/or contact data using at least one filtering criteria. In step 4520, the user determines which report to generate. The user can generate a contact list, a mail merge, an email blast, address label or an exported data file in a specified data format. Additionally, the user can generate a report that indicates which postal addresses are incomplete (i.e. missing city, state, zip, etc), or which contacts are missing email addresses. In step 4521, the system automatically determines which part of the address is unqualified and, if a critical field includes a null value (unqualified) then the system, in step 4523, requests the user to update the contact data information by generating a dialog box including data fields for contact information for the particular client. A user can selectively modify contact data to change the status of the address from unqualified to qualified. These addresses are then provided, at step 4522, to the mail merge application which automatically merges a template marketing letter with the filtered client/contact addresses. The merged letter is provided in step 4524 to an email application which generates email messages to the selected clients/contacts including the marketing letter.

In response to selecting generate a compliance report in step 4503, the report generation application generates, for example, a plurality of user selectable image elements in a display window that each correspond to a type of compliance report. In step 4505, the user can selectively generate a report including data corresponding to incoming correspondence within a user specified date range or in a date range that is automatically inserted in response to a trigger event (i.e. end of quarter). In step 4507, the user can selectively generate a report including data corresponding to outgoing correspondence to at least one client or group of clients. In step 4511, the user can selectively generate a report including data identifying all monies received from any client or contact over a specified time period. The compliance reports also includes data identifying how the monies received are to be disbursed and where and how the monies and/or documents associated with the monies were forwarded.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

We claim:

1. A practice management system comprising:
a repository including
client information data including at least one client identifier and at least one client characteristic associated with said client,
client account data identifying at least one account linked to said client via said at least one client identifier, said client account data including data representing a financial portfolio associated with said client and having an initial balance value and a risk value; and
risk allocation profile data including a risk allocation profile type and a risk allocation value; and
a data processor electrically coupled to said repository that
acquires said client information data and said client account data including said financial portfolio having said initial balance value and calculates an updated balance value for said financial portfolio based on said risk allocation profile type and comparing said risk allocation value of said risk allocation profile type with said risk value of the financial profile data; and
modifies said client account data in response to said comparison to include said calculated updated balance value for said financial portfolio data.

2. The practice management system according to claim 1, wherein
said risk allocation profile data is based on any of (a) a conservative investment strategy, (b) a moderate-conservative investment strategy, (c) a moderate investment strategy, (d) a moderate-aggressive investment strategy and (e) an aggressive investment strategy.

3. The practice management system according to claim 1, further comprising
a template building processor that generates a display image including a user selectable image element that enables a user to selectively create risk allocation profile data by selecting at least one type of financial instruments having a first risk characteristic associated therewith and assigns a risk value to said at least one type of selected financial instrument.

4. The practice manage system according to claim 3, wherein
said risk characteristic includes data representing a total percentage of a financial portfolio that said selected financial instrument should comprise in order to match said risk value of said risk allocation profile.

5. The practice management system according to claim 1, wherein
financial profile data includes
a plurality of records associated with a plurality of financial instrument data that comprise the financial portfolio and data representing at least one financial instrument characteristic associated with a respective one of said plurality of financial instruments, and further comprising
a display processor that generates a display image for display on a display device, said display image includes said acquired client information data and client account data and said plurality of records and said at least one financial instrument characteristic is presented in user modifiable data fields, and
wherein said data processor
enables the user to selectively modify the values of said at least one financial characteristic data for respective financial instrument data, and
calculates an updated balance value for said financial portfolio using said modified financial characteristic data.

6. The practice management system according to claim 5, wherein
said financial characteristic data includes data representing at least one of (a) a monetary value associated with said financial instrument, (b) a percentage value of said financial instrument in said financial portfolio, (c) a desired value to be associated with said financial instrument.

7. The practice management system according to claim 1, further comprising
a communication processor electrically coupled to said data processor for communicating message data associated with said client to a user, and
said data processor generates a reallocation message data including said financial profile data and data identifying a source and destination for client funds to be reallocated in response to the calculation of said updated balance value according to said risk allocation profile.

8. The practice management system according to claim 1, wherein
Said data processor automatically generates a transaction message including data representing a type of transaction and at least one task associated with said type of transaction in response to calculation of said updated balance value according to said risk allocation profile, said transaction message is provided to a user to notify said user of task required to rebalance said client financial profile to have a risk value associated with said risk allocation profile.

9. The practice manage system according to claim 1, wherein
said risk allocation profiles stored in said repository further include user access privilege data associated therewith enabling selective user access to respective ones of said risk allocation profiles.

10. A practice management method comprising the activities of:
storing, in a repository,
client information data including at least one client identifier and at least one client characteristic associated with said client,
client account data identifying at least one account linked to said client via said at least one client identifier, said client account data including data representing a financial portfolio associated with said client and having an initial balance value and a risk value; and
risk allocation profile data including a risk allocation profile type and a risk allocation value; and
acquiring, via a data processor, said client information data and said client account data including said financial portfolio having said initial balance value and calculates an updated balance value for said financial portfolio based on said risk allocation profile type comparing the risk allocation value of the risk allocation profile type with the risk value of the financial profile data; and
modifying, via a data processor, said client account data in response to said comparison to include said calculated updated balance value for said financial portfolio data.

11. The practice management method according to claim 10, wherein
said risk allocation profile data is based on any of (a) a conservative investment strategy, (b) a moderate-conservative investment strategy, (c) a moderate investment strategy, (d) a moderate-aggressive investment strategy and (e) an aggressive investment strategy.

12. The practice management method according to claim 10, further comprising the activity of
generating a display image using a template building processor including a user selectable image element that enables a user to selectively create risk allocation profile data by selecting at least one type of financial instruments having a first risk characteristic associated therewith and assigns a risk value to said at least one type of selected financial instrument.

13. The practice manage method according to claim 12, wherein
said risk characteristic includes data representing a total percentage of a financial portfolio that said selected financial instrument should comprise in order to match said risk value of said risk allocation profile.

14. The practice management method according to claim 10, wherein
financial profile data includes
a plurality of records associated with a plurality of financial instrument data that comprise the financial portfolio and data representing at least one financial instrument characteristic associated with a respective one of said plurality of financial instruments, and further comprising the activity of
generating, via a display processor, a display image for display on a display device, said display image includes said acquired client information data and client account data and said plurality of records and said at least one financial instrument characteristic is presented in user modifiable data fields, and
enabling the user to selectively modify the values of said at least one financial characteristic data for respective financial instrument data, and
calculating an updated balance value for said financial portfolio using said modified financial characteristic data.

15. The practice management method according to claim 14, wherein
said financial characteristic data includes data representing at least one of (a) a monetary value associated with said financial instrument, (b) a percentage value of said financial instrument in said financial portfolio, (c) a desired value to be associated with said financial instrument.

16. The practice management method according to claim 10, further comprising the activity of
communicating message data associated with said client to a user, and
generating a reallocation message data including said financial profile data and data identifying a source and destination for client funds to be reallocated in response to the calculation of said updated balance value according to said risk allocation profile.

17. The practice management system according to claim 10, further comprising the activity of
automatically generating, via said data processor, a transaction message including data representing a type of transaction and at least one task associated with said type of transaction in response to calculation of said updated balance value according to said risk allocation profile, said transaction message is provided to a user to notify said user of task required to rebalance said client financial profile to have a risk value associated with said risk allocation profile.

18. The practice manage system according to claim 1, further comprising the activity of
Restricting user access to said risk allocation profiles stored in said repository using user access privilege data associated with said risk allocation profile.

19. A computer readable medium including machine executable program code embodied thereon, said machine executable code being executed by a computing device to implement the method of claim 10.
